(19) United States
(12) Patent Application Publication
(10) Pub. No.: US 2014/0254810 A1
(43) Pub. Date: Sep. 11, 2014

(54) MICROPHONE SYSTEM TO CONTROL INTERMODULATION PRODUCTS

(71) Applicant: QUALCOMM Incorporated, San Diego, CA (US)

(72) Inventors: Victor A. Abramsky, Southhampton, PA (US); Andrzej Partyka, Bridgewater, NJ (US); Robert P. Gilmore, Poway, CA (US)

(73) Assignee: QUALCOMM Incorporated, San Diego, CA (US)

(21) Appl. No.: 13/788,810

(22) Filed: Mar. 7, 2013

(51) Int. Cl. H04R 3/00

(52) U.S. Cl. CPC H04R 3/005
USPC 381/58

(57) ABSTRACT

In a particular embodiment, a system includes a controller configured to receive proximity data associated with a first device of a plurality of devices. The proximity data indicates a relative location of each of one or more devices of the plurality of devices with respect to the first device. The controller is further configured to determine an estimated intermodulation product. The estimated intermodulation product is calculated based on the proximity data. The controller is further configured to initiate transmission of one or more commands, based on the estimated intermodulation product, to at least one device of the plurality of devices.

### I. FIELD OF THE DISCLOSURE

The present disclosure is generally directed to a microphone system configured to control intermodulation products.

### II. BACKGROUND

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet Protocol (IP) telephones, can communicate voice and data packets over wireless networks. Further, many such wireless computing devices include other types of devices that are incorporated therein. For example, wireless computing devices can also include a digital still camera, a digital video camera, a digital recorder, and an audio file player. Also, such wireless computing devices include a processor that can process executable instructions, including software applications, such as a web browser application, that can be used to access the Internet. As such, these wireless computing devices can include significant computing capabilities. As use of wireless computing devices increase, bandwidth allocated to wireless communication may become congested with increased traffic. To alleviate such congestion, one possible approach is to allocate bandwidth to wireless computing devices that was previously allocated to other devices or systems. Allocating bandwidth from other devices or systems for use by wireless computing devices may impact the operation of such other devices or systems.

One type of system having bandwidth that may be allocated to wireless computing devices is microphone systems, such as a Professional Wireless Microphone System (PWMS). A microphone system may be used in theater and concert productions, sport events, conferences, television studios, and recording studios. Microphone systems may include transmitter links and receiver links. A microphone system may include multiple microphones that transmit audio signals to one or more microphone receivers. The microphone system may also include one or more in-ear monitor (IEM) transmitters that transmit an audio mix to one or more IEM receivers.

The microphone system uses a large frequency spectrum (e.g., bandwidth) to avoid inter-carrier interference that may negatively affect performance of the microphone system. For example, intermodulation products generated by a particular device (e.g., a microphone) may be transmitted on frequencies that may be used by other wireless devices (e.g., a wireless microphone device and/or a wireless IEM device) and may interfere with signals transmitted or received by other wireless devices that are in close proximity to the particular device. For example, two or more transmitter devices may be located in close proximity and each device may transmit over a different channel. Each device may generate intermodulation products on a different channel (i.e., a channel different from the transmit channel) that may block or degrade reception of signals on the other channel.

In order to combat intermodulation products (“intermods”), typical microphone systems define each channel within discrete bands of a frequency spectrum (e.g., channels) to avoid areas where intermodulation products occur. These microphone systems do not equally space communication channels; rather, communication channels are spaced apart and have “gaps” (e.g., frequency bands) where intermodulation products are located (e.g., located on a frequency spectrum). A size of the frequency spectrum increases as the number of channels (a number of transmit devices) used in the microphone system increases. For example, a frequency spectrum of 70 megahertz (MHz) may be used to accommodate 30 microphones. The gaps between channels may vary in size and result in bandwidth that is not utilized by the microphone system for signal transmissions.

In addition to spacing channels within the frequency spectrum to avoid intermodulation products, other techniques may also be employed at devices in the microphone system to reduce the effects of intermodulation products. For example, a transmit power of a microphone transmitter may be increased (e.g., set to a high level) or intermodulation cancellation circuitry may be employed at a microphone transmitter. Each of these other techniques have certain disadvantages, such as reduced output power at an antenna, reduced battery life, increased power consumption, decreased link (i.e., wireless link) reliability, increased expense, and increased size of the wireless device.

Additionally, channel assignment for each device of the microphone system is static. For example, in a system associated with a theater production, techniques to address the effects of intermodulation products are determined and implemented (activated) prior to performance of the theater production. For example, an audio engineer may activate intermodulation cancellation circuitry, allocate a channel, or set a transmission power level, etc., of a device of the microphone system. Theater productions are typically choreographed and intermodulation products may be identified and addressed prior to a final performance. During the final performance, the channel assignments, power levels, or intermodulation cancellation settings are not changed. Thus, the microphone system does not adapt to changes that may occur during the production.

### III. SUMMARY

A microphone system, such as a professional wireless microphone system (PWMS), may be configured to control intermodulation products. The microphone system may be configured to dynamically manage intermodulation products. Effectively managing intermodulation products promotes efficient use of audio frequency spectrum of the microphone system. The microphone system may include a plurality of devices including one or more in-ear monitor (IEM) receivers, an IEM transmitter, a controller (e.g., a control plane), a microphone receiver, one or more microphone transmitters, or a combination thereof.

The microphone system may operate over a frequency spectrum that includes one or more audio frequency channels and one or more digital control channels (DCCh) (e.g., one or more out-of-band digital control channels). The one or more audio frequency channels may be spaced every 300-400 kilohertz (kHz) per carrier within a first portion of the frequency spectrum. In a particular embodiment, the frequency carriers are equally spaced every 350 kHz to conserve bandwidth. The one or more digital control channels may be used by the plurality of devices of the microphone system to exchange proximity information (e.g., location information), control information (e.g., one or more commands), communication information (e.g., information associated with one or more audio signals), or a combination thereof. Accordingly, a microphone system that uses 30 microphones and controls intermodulation products may have a frequency spectrum of 9-12 MHz. Such a system advantageously conserves bandwidth as compared to a microphone system that widely spaces audio channels and includes gaps to avoid intermodulation products.

A particular device of the plurality of devices of the microphone system may be configured to determine proximity data that indicates a relative location of one or more other devices with respect to the particular device. In a particular embodiment, one or more of the plurality of devices is configured to determine corresponding proximity data. The particular device may include a location module to determine the proximity data of the particular device. The location module may include one or more ultra-wide band components that are configured to determine the proximity data. The particular device may communicate a packet including the proximity data via a digital control channel to a controller. The packet may also include a device identifier of the particular device, one or more audio parameters (e.g., a transmission power level or an assigned audio frequency channel), or a combination thereof.

A microphone receiver, such as a microphone receiver including a multichannel receiver including a single set of diversity antennas, may be configured to receive and process analog audio information from one or more microphone transmitters. Additionally, the microphone receiver may be configured to maintain audio frequency channel spacing and a signal-to-noise ratio above a threshold for each assigned audio frequency channel. The microphone receiver may determine (e.g., measure) a signal-to-noise ratio of an audio signal received from a microphone transmitter via an audio frequency channel.

The microphone receiver may also be configured to receive digital control channel transmission information (e.g., data packets including proximity data) from a microphone transmitter. Receipt of the digital control channel transmission information is independent of whether the microphone receives and processes audio frequency channels for the microphone transmitter. The microphone receiver may also be configured to determine a signal strength corresponding to a received data communication (e.g., a data packet) from a device via the digital control channel. The microphone receiver may send the signal-to-noise ratio value and the signal strength value to the controller via a digital communication channel.

The controller may receive information via one or more digital control channels from one or more of the plurality of devices of the microphone system. For example, the information may include proximity data, one or more audio parameters (e.g., a transmission power level or an assigned audio frequency channel), or a combination thereof from one or more devices of the plurality of devices. The information may also include one or more signal-noise-ratio values, one or more signal strength values, or a combination thereof.

The controller may dynamically calculate and estimate frequency and strength of potentially harmful intermodulation products (e.g., intermodulation interference) based on the information received via the digital control channel. For example, the controller may calculate (e.g., automatically calculate) frequencies and strengths of intermodulation products in real-time or near real-time during a performance or presentation. The controller may determine an estimated intermodulation product that affects an audio signal transmitted or received by a particular device (e.g., a microphone transmitter or an IEM receiver) of the plurality of devices. Based on the estimated intermodulation product, the controller may take a corrective action (e.g., may send one or more commands to devices) to reduce or eliminate the intermodulation product with respect to the particular device.

The controller may select a corrective action based on the received information (e.g., proximity data, signal-to-noise ratio value, signal strength values, etc.). The controller may initiate transmission of the one or more commands associated with the corrective action to at least one device of the plurality of devices. The one or more commands may direct a device to take a corrective action, such as to change channels from a first audio channel to a second audio channel, adjust a transmission power level, activate intermodulation cancellation circuitry, adjust a bias current associated with an amplifier of a transmitter circuit, adjust a bias voltage associated with the amplifier, or a combination thereof. By managing and controlling intermodulation products, a microphone system may operate using a relatively compact frequency spectrum in which audio channels are equally spaced. Further, selectively implementing corrective actions to address intermodulation interference issues, such as by changing channel assignments, adjusting transmission power levels, and selectively activating cancellation circuitry, may increase battery life of one or more wireless devices of the microphone system and improve performance of devices in the microphone system.

In a particular embodiment, a system includes a controller configured to receive proximity data associated with a first device of a plurality of devices. The proximity data indicates a relative location of each of one or more devices of the plurality of devices with respect to the first device. The controller is further configured to determine an estimated intermodulation product. The estimated intermodulation product is calculated based on the proximity data. The controller is further configured to initiate transmission of one or more commands, based on the estimated intermodulation product to at least one device of the plurality of devices.

In another particular embodiment, a method includes receiving proximity data associated with a first device of a plurality of devices. The proximity data indicates a relative location of each of one or more devices of the plurality of devices with respect to the first device. The method also includes determining an estimated intermodulation product. The estimated intermodulation product is calculated based on the proximity data.

In a further particular embodiment, an apparatus includes means for receiving proximity data associated with a first device of a plurality of devices. The proximity data indicates a relative location of each of one or more devices of the plurality of devices with respect to the first device. The apparatus also includes means for determining an estimated intermodulation product. The estimated intermodulation product is calculated based on the proximity data.

In another particular embodiment, a non-transitory computer readable medium includes instructions that, when executed by a processor, cause the processor to receive proximity data associated with a first device of a plurality of devices. The proximity data indicates a relative location of each of one or more devices of the plurality of devices with respect to the first device. The non-transitory computer readable medium further includes instructions that cause the processor to determine an estimated intermodulation product. The estimated intermodulation product is calculated based on the proximity data.

One particular advantage provided by the disclosed embodiments is a microphone system that is configured to dynamically manage intermodulation interference to efficiently use audio frequency spectrum. The microphone system advantageously reduces or eliminates intermodulation products generated by transmitter devices and thereby controls the effects of intermodulation interference experience by other devices. Efficient use of the frequency spectrum by the microphone system allows allocation of spectrum for other uses, such as for wireless communication devices.

Other aspects, advantages, and features of the present disclosure will become apparent after review of the application, including the following sections: Brief Description of the Drawings, Detailed Description, and the Claims.

### IV. BRIEF DESCRIPTION OF THE DRAWINGS

FIG. 1 is a diagram of a first illustrative embodiment of a microphone system that communicates proximity data via one or more digital control channels to a controller to manage intermodulation products;

FIG. 2 is a diagram of a second illustrative embodiment of a microphone system that communicates proximity data via one or more digital control channels to a controller to manage intermodulation products;

FIG. 3 is depicts illustrative data structures utilized by a controller of a microphone system;

FIG. 4 is an graph that illustrates channel allocation and receiver impairments of a microphone system;

FIG. 5 is a block diagram of an illustrative embodiment of digital communications, via one or more digital control channels, between different devices in a microphone system;

FIG. 6 is a ladder diagram of an illustrative embodiment of a method to communicate proximity data to a controller of a microphone system;

FIG. 7 is a flow diagram of a first illustrative embodiment of a method to operate a controller of a microphone system;

FIG. 8 is a flow diagram of a second illustrative embodiment of a method to operate a controller of a microphone system;

FIG. 9 is a flow diagram of an illustrative embodiment of a method to operate a microphone receiver of a microphone system; and

FIG. 10 is a block diagram of a particular embodiment of a device included in a wireless microphone system.

### V. DETAILED DESCRIPTION

Particular embodiments of the present disclosure are described below with reference to the drawings. In the description, common features are designated by common reference numbers throughout the drawings.

A microphone system may be configured to dynamically manage intermodulation products in a microphone system. For example, a controller of the microphone system may receive proximity data associated with a first device of the plurality of devices. The proximity data may indicate a relative location of each of one or more devices of the plurality of devices with respect to the first device. The proximity data may be included in a report (e.g., including one or more data packets) that includes a device identifier and one or more audio parameters (signal strength, frequency channel, etc.) associated with the first device. The controller may estimate an intermodulation product. The estimated intermodulation product may be determined based at least in part on the proximity data. For example, if the controller is able to determine a physical proximity of multiple transmitter devices and each transmitter device's transmission output power level, the controller can estimate which transmitter devices (e.g., a group of transmitters) create intermodulation products and the frequency and levels of those estimated intermodulation products. Additionally, the controller can confirm (e.g., determine) whether any of the estimated intermodulation products cause desense at one or more receiver devices based on a signal-to-noise ratio value corresponding to a frequency channel associated with the estimated intermodulation product.

The controller may identify one or more commands (e.g., commands corresponding to a corrective action) to reduce or eliminate the estimated intermodulation products that affect signals transmitted or received by the first device. The controller may determine the one or more commands based on the proximity data, signal quality data (e.g., signal-to-noise ratio values or signal strength values received from a microphone transmitter), audio parameter data received from multiple devices of the plurality of devices, or a combination thereof. The controller may initiate transmission of the one or more commands to at least one device of the plurality of devices.

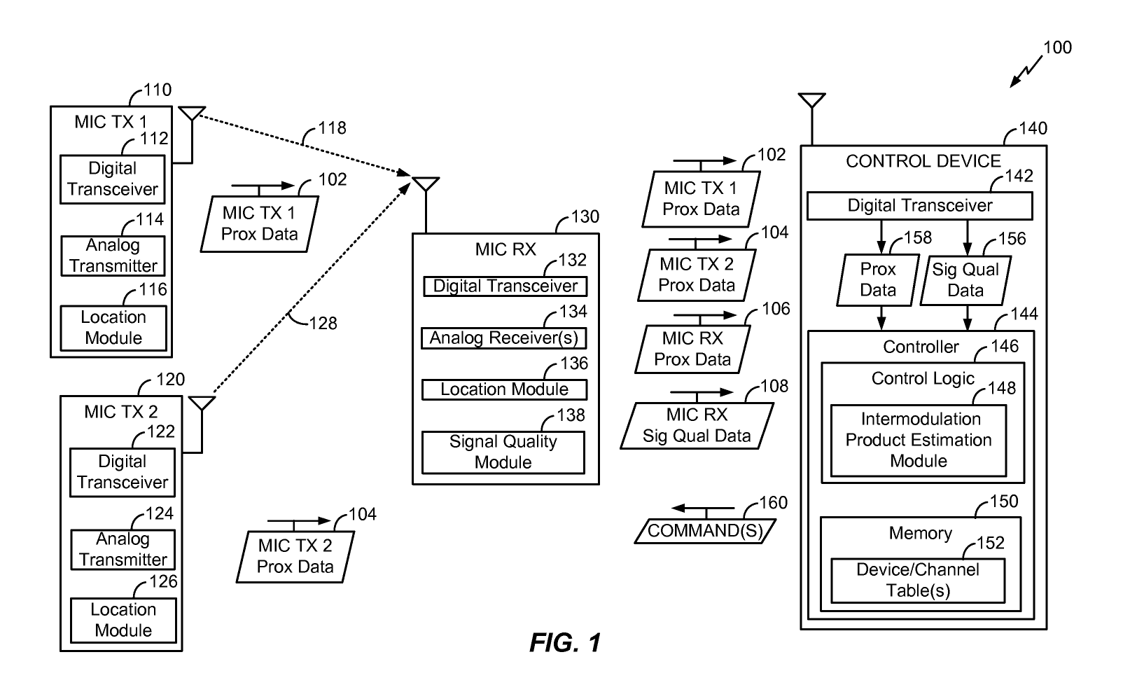

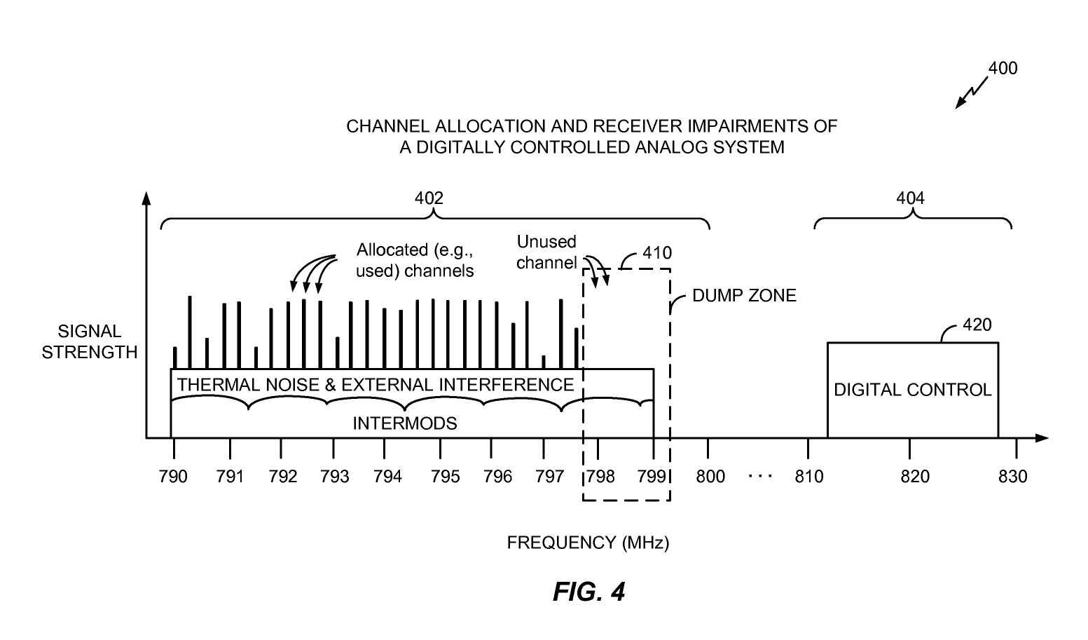

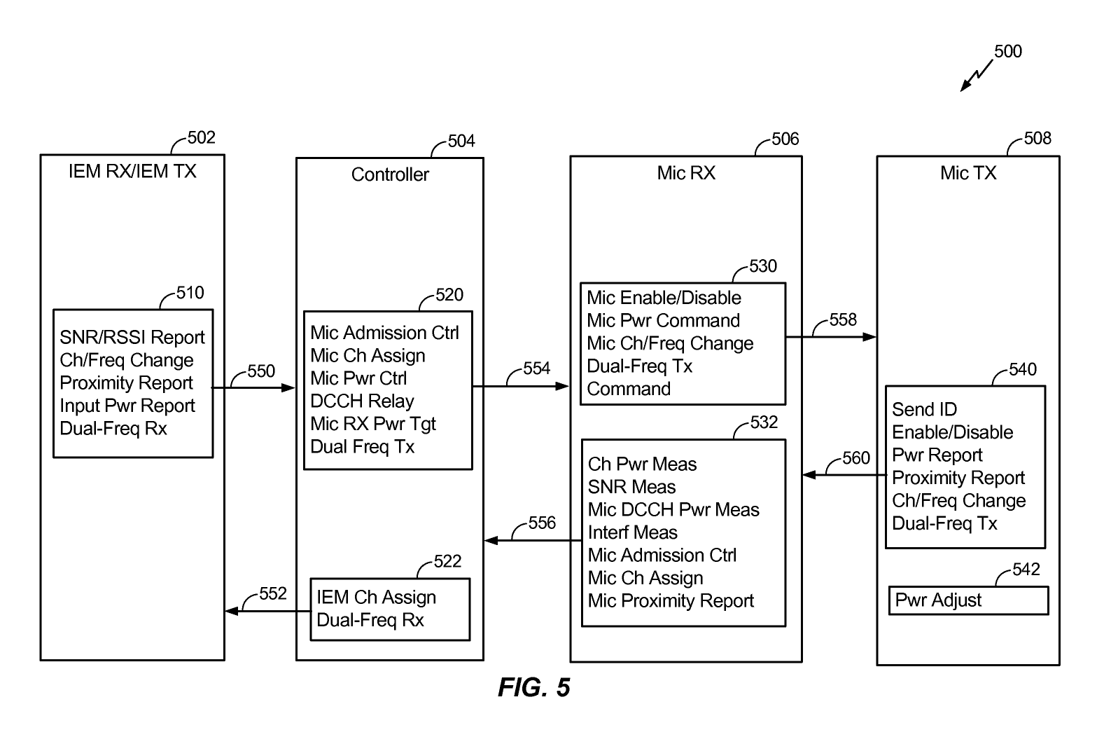

FIG. 1 illustrates a first particular embodiment a microphone system 100, such as a Professional Wireless Microphone System (PWMS). The microphone system 100 may operate over a frequency spectrum that includes one or more audio frequency channels to enable communication of analog audio signals and one or more digital control channels (DCCh) (e.g., one or more out-of-band digital control channels). The digital control channels may enable communication of digital signals, as further described with respect to FIG. 4. The digital signals communicated via the digital control channels may be used to exchange information between the devices of the microphone system 100, as further described with respect to FIG. 5. The microphone system 100 may include a first microphone transmitter (TX) 110, a second microphone transmitter 120, a microphone receiver (RX) 130, and a control device 140. The microphone system 100 may also include one or more additional devices (not shown), such as an in-ear monitor (IEM) receiver and/or an IEM transmitter.

The first microphone transmitter 110 may include a digital transceiver 112, an analog transmitter 114, and a location module 116. In a particular embodiment, the first microphone transmitter 110 may include a processor and a memory.

The first microphone transmitter 110 may use the analog transmitter 114 to transmit one or more audio signals via an audio frequency channel (e.g., a radio frequency (RF) carrier frequency) assigned to the first microphone transmitter 110. For example, to transmit an audio signal of the first microphone transmitter 110, the microphone transmitter 110 may modulate the RF carrier frequency by the audio signal. The first microphone transmitter 110 may transmit the one or more audio signals to the microphone receiver 130 via a transmission path 118 using an audio frequency channel (e.g., an RF carrier frequency) assigned to the first microphone transmitter 110. The first microphone transmitter 110 may also communicate (e.g., send, receive, or a combination thereof) digital signals via a digital control channel to one or more other devices of the microphone system 100. For example, the first microphone transmitter 110 may communicate information (e.g., proximity information, control information, audio parameter information, etc.) using the digital signals to one or more other devices of the microphone system 100, as further described with respect to FIG. 5.

The location module 116 may enable the first microphone transmitter 110 to determine proximity data, such as first microphone transmitter proximity data 102 associated with the first microphone transmitter 110. The proximity data may indicate a relative location of each of one or more devices with respect to the first microphone transmitter 110. For example, the proximity data 102 may indicate a relative location of another device, such as the second microphone transmitter 120 or the microphone receiver 130, with respect to the first microphone transmitter 100. In a particular embodiment, the relative location corresponds to a distance between the first microphone 110 and another device. The first microphone transmitter 110 may transmit the first microphone transmitter proximity data 102 via the digital transceiver 112 to the control device 140.

The second microphone transmitter 120 may include a digital transceiver 122, an analog transmitter 124, and a location module 126. The second microphone transmitter 120 may operate in a similar manner as the first microphone transmitter 110. For example, the second microphone 120 may transmit, from the analog transmitter 124, one or more audio signals to the microphone receiver 130 via a transmission path 128 using an audio frequency channel assigned to the second microphone transmitter 120. The audio frequency channel assigned to the second microphone transmitter 120 may be a different audio frequency channel than the audio frequency channel assigned to the first microphone transmitter 110. The second microphone transmitter 120 may use the digital transceiver 122 to communicate (e.g., send, receive, or a combination thereof) digital signals via a digital control channel to one or more other devices of the microphone system 100. The digital control channel used by the second microphone transmitter 120 may be the same digital control channel or a different digital control channel than the channel used by the first microphone transmitter 110. The location module 126 may enable the second microphone transmitter 120 to determine proximity data, such as second microphone transmitter proximity data 104 associated with the second microphone transmitter 120. The second microphone transmitter proximity data 104 may be transmitted via the digital transceiver 122 to the control device 140.

The microphone receiver (RX) 130 may include a digital transceiver 132, an analog receiver(s) 134, a location module 136, and a signal quality module 138. In a particular embodiment, the microphone receiver 130 may include a processor and a memory. The digital transceiver 132 and the location module 136 of the microphone receiver 130 may function in a similar manner as the digital transceiver 112 and the location module 116 of the first microphone transmitter 110 and the digital transceiver 122 and the location module 126 of the second microphone transmitter 120, respectively. For example, the microphone receiver 130 may use the digital transceiver 132 to communicate (e.g., send, receive, or a combination thereof) digital signals via a digital control channel to one or more other devices of the microphone system 100. The location module 126 may enable the microphone receiver 130 to determine proximity data, such as microphone receiver proximity data 106 associated with the microphone receiver 130. The microphone receiver proximity data 106 may be transmitted via the digital transceiver 132 to the control device 140.

The microphone receiver 130 may receive one or more audio signals via the analog receiver 134. In a particular embodiment, the microphone receiver 130 may include a multichannel receiver that uses a single set of diversity antennas. The microphone receiver 130 may be assigned to receive audio signals via one or more audio frequency channels that are each assigned to a corresponding microphone transmitter, such as the first microphone transmitter 110 or the second microphone transmitter 120. The microphone receiver 130 may maintain (e.g., space) one or more audio frequency channels within a frequency spectrum used by the microphone system 100, as described further with respect to FIG. 4. Consecutive audio frequency channels may be spaced every 300-400 kilohertz (kHz) per carrier within the frequency spectrum. In a particular embodiment, the frequency carriers are equally spaced every 350 kHz. The microphone receiver 130 may receive a first audio signal from the first microphone transmitter 110 and a second audio signal from the second microphone transmitter 130. The microphone receiver 130 may process one or more of the received audio signals and may provide the processed audio signals to another device, such as to an audio mixer or sound board (not shown) of the microphone system 100. The audio mixer or sound board may provide the processed audio signals to a speaker (not shown) coupled to the microphone system 100.

The signal quality module 138 may be configured to determine signal quality data (e.g., microphone receiver signal quality data 108) associated with one or more audio frequency channels (e.g., one or more audio signals received by the microphone receiver 130), one or more digital control signals received via the digital control channel(s), or a combination thereof. For example, the signal quality module 138 may determine signal quality data, such as a signal-to-noise ratio value, a noise power value, a received signal strength value, or a combination thereof. The microphone receiver signal quality data 108 may be transmitted by the digital transceiver 132 to the control device 140.

The control device 140 may include a digital transceiver 142 and a controller 144. The digital transceiver 142 of the control device 140 may function similarly to the digital transceiver 112 of the first microphone transmitter 110. Although the control device 140 is depicted in FIG. 1 as a separate device than the other devices of the microphone system 100, in alternate embodiments, the control device 140, or functionality thereof, may reside in another device or may be distributed among multiple other devices. For example, the control device 140, or functionality thereof, may be included in the microphone receiver 130 or may be distributed among multiple microphone receivers of the microphone system 100.

The digital transceiver 142 of the control device 140 may be configured to receive digital communications from one or more devices of the microphone system 100. The digital transceiver 142 may provide proximity data 158 and signal quality data 156 to the controller 144. The proximity data 158 may include or correspond to the first microphone transmitter proximity data 102, the second microphone transmitter proximity data 104, the microphone receiver proximity data 106, or a combination thereof. The signal quality data 156 may include or correspond to the microphone receiver signal quality data 108.

The controller 144 may include control logic 146 and a memory 150 that stores device/channel table(s) 152. The control logic 146 may include an intermodulation product estimation module 148. In a particular embodiment, the control logic 146, the intermodulation product estimation module 148, or a combination thereof, may be included in one or more processors. The intermodulation product estimation module 148 may calculate one or more estimated intermodulation products (e.g., frequencies and strengths) based on information received via one or more digital signals. For example, a frequency and a power of an intermodulation product generated by two or more transmitter devices may be calculated (e.g., estimated) based on (e.g., as a function of) a radio frequency (RF) carrier frequency of each transmitter device, an output power of each transmitter device, and a distance between each transmitter device. The frequency and the power of the intermodulation product generated by the two or more transmitter devices may further be calculated based on one or more electrical implementation characteristics of the transmitter devices, such as reverse isolation characteristics or third order intercept point (IP3) characteristics. The electrical implementation characteristics of a particular transmitter device may be determined based on a hardware design of the particular transmitter device. In a particular embodiment, one or more estimated intermodulation products are determined based at least in part on the received proximity data 158 (e.g., proximity data from one or more devices of the microphone system 100).

The intermodulation product estimation module 148 may determine an estimated intermodulation product. For example, the intermodulation product estimation module 148 may determine an estimated intermodulation product that affects an audio signal transmitted or received by a particular device (e.g., a microphone transmitter or an IEM receiver) of the plurality of devices. In a particular embodiment, the intermodulation product estimation module 148 determines an estimated intermodulation product that affects an audio signal transmitted by a microphone transmitter of the plurality of devices. The controller 144 may determine a corrective action to manage interference associated with the intermodulation product at the particular device based on information, such as the received proximity data 158, the received signal quality data 156, the device/channel tables 152, or a combination thereof. The controller logic 146 may determine (e.g., select) one or more commands (e.g., command(s) 160) to implement the corrective action. As another example, the commands 160 may direct a device (e.g., a device generating the estimated intermodulation product or a device affected by the estimated intermodulation product, such as the first microphone transmitter 110, the second microphone transmitter 120, the microphone receiver 130, or other device) to change from a first audio channel to a second audio channel, adjust a transmission power level, activate intermodulation cancellation circuitry, adjust a bias current associated with an amplifier of a transmitter circuit, adjust a bias voltage associated with the amplifier, or a combination thereof.

The commands 160 may be transmitted by the digital transceiver 142 to one or more devices of the microphone system 100 via one or more digital control channels. Execution of the commands 160 by the respective one or more devices may reduce or eliminate the estimated intermodulation product interference calculated by the intermodulation product estimation module 148.

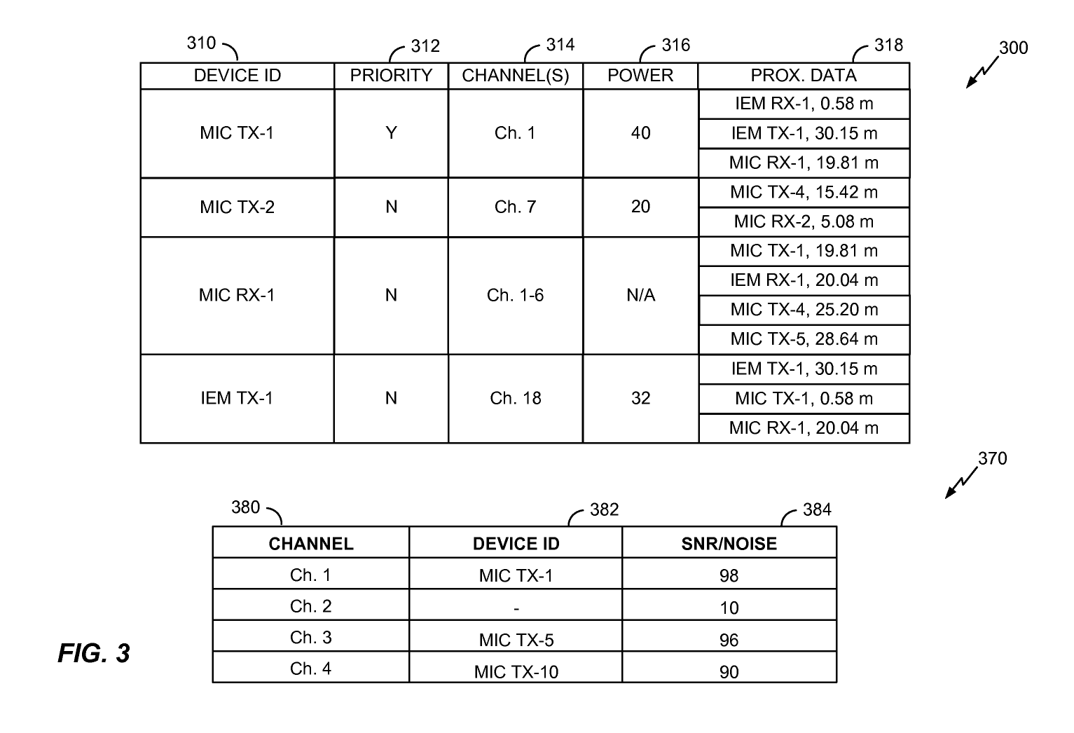

The memory 150 may include the device/channel table(s) 152. The device/channel tables 152 stores information associated with one or more devices of the microphone system 100, as described further with reference to FIG. 3. For example, the device/channel tables 152 may store proximity data received from and audio frequencies allocated to each of the first microphone transmitter 110, the second microphone transmitter 120, and the microphone receiver 130. The controller 144 may populate, maintain, and/or update the device/channel tables 152 based on the proximity data 158, the signal quality data 156, the commands 160, or a combination thereof.

During operation of the microphone system 100, one or more devices of the microphone system 100 may determine corresponding proximity data. The proximity data for each of the one or more devices may be transmitted to the control device 140 via one or more digital control channels. For example, the first microphone transmitter 110 may determine proximity data (e.g., the proximity data 102) that indicates a relative location of each of one or more devices with respect to the first microphone transmitter 110. The first microphone transmitter 110 may transmit the proximity data 102 to the control device 140.

The microphone receiver 130 may determine signal quality data 108 (e.g., a signal-to-noise ratio value, a noise power value, a received signal strength value, or a combination thereof) associated with one or more audio frequency channels (e.g., one or more audio signals received by the microphone receiver 130), one or more digital control signals received via the digital control channel(s), or a combination thereof. The microphone receiver 130 may transmit the microphone receiver signal quality data 108 to the control device 140.

The control device 140 may receive the proximity data (e.g., the first microphone transmitter proximity data 102) from the one or more devices and may receive the microphone receiver signal quality data 108 from the microphone receiver 130. The controller 144 of the control device 140 may determine an estimated intermodulation product that affects a signal transmitted by a particular device (e.g., the first microphone transmitter 110) of the microphone system 100. The estimated intermodulation product that affects the particular device may be determined based on the proximity data 102 received by the control device 140. For example, the controller 144 may calculate one or more estimated intermodulation products (e.g., frequencies and strengths) based at least in part on proximity data received from one or more devices of the microphone system 100.

The controller 144 may generate one or more commands 160 associated with a corrective action to reduce or eliminate the estimated intermodulation product that affects the particular device. The one or more commands 160 may be based on an estimated intermodulation product calculated by the controller 144. The controller 144 initiates transmission of the one or more commands to at least one device of the microphone system 100. After the commands 160 are executed (i.e., corrective action is taken) by the one or more devices, the estimated intermodulation product affecting the particular device may be reduced or eliminated.

In a particular embodiment, data communicated via one or more digital control channels between a first device and a second device of the microphone system may be sent from the first device to the second device either directly from the first device to the second device or indirectly via one or more other devices. In a particular embodiment, the first device, the second device, and the one or more other devices form a mesh network (e.g., a multi-node self-organizing mesh network) and each device of the microphone system 100 may communicate with the controller device 140 via the mesh network.

In another particular embodiment, a location module, such as the location module 116 of the first microphone transmitter 110, the location module 126 of the second microphone transmitter 120, or the location module 136 of the microphone receiver 130, may be configured to determine proximity data. For example, each device including a location module may be time synchronized to enable proximity locations to be estimated based on time of arrival (TOA) or signal strength determinations of digital communications. To time synchronize the devices of the microphone system 100, the controller device 140 or other devices may be configured to broadcast a pilot signal to one or more devices of the microphone system 100.

As another example, each device of the plurality of devices may include a corresponding ultra-wideband component. In a particular embodiment, each device including a location module is equipped with ultra-wide band (UWB) proximity and communication circuitry (e.g., Zigbee, Bluetooth, Peanut, etc.) to determine and communicate proximity information. In a particular embodiment, each device in the microphone system 100 utilizes UWB circuitry (e.g., circuitry enabling communication in an 8 gigahertz (GHz) frequency band). The one or more digital control channels may operate in a frequency band, such as an 800 megahertz (MHz) frequency band, a 900 MHz frequency band, an 8 GHz frequency band, or another frequency band. In a particular embodiment, the one or more digital control channels operate in the 900 MHz frequency band. To determine proximity data using the UWB circuitry, a first device and a second device may establish a communication link and may exchange data packets between the first device and the second device to calculate a propagation delay. The propagation delay may be associated with a first packet sent from the first device and received by the second device and a second packet sent from the second device and received by the first device. Based on the propagation delay, a distance between the first device and the second device may be calculated.

In a particular embodiment, the first microphone transmitter 110 may include reverse isolation circuitry, an adjustable synthesizer/oscillator configured to switch from a first channel to a second channel, and an adjustable power transmitter. The reverse isolation circuitry of a power amplifier may enable the first microphone transmitter 110 to prevent an amount (e.g., 7-12 dB) of self-desense from nearby transmitters. The first microphone transmitter 110 may also be configured to adjust an output power level of the analog transmitter 114 (e.g., a power amplifier output level) in 1 dB increments over a 40 dB range. The adjustable synthesizer/oscillator is configured to switch from a first channel to a second channel and may include a dual transmitter capability (e.g., a make-before-break switchover) to enable the first microphone transmitter 110 to establish a communication link (e.g., a transmission) via the second analog frequency channel prior to stopping (e.g., disconnecting) transmission via the first analog frequency channel.

In a particular embodiment, the microphone receiver 130 may be configured to maintain audio frequency channel spacing, a power control target associated with each audio frequency channel, a minimum signal-to-noise ratio for each audio frequency channel, a combination thereof. For example, the microphone receiver 130 controls (e.g., maintains) a signal power of each channel received at the receiver based on a threshold power level. The microphone receiver 130 may control a signal power of a channel associated with a microphone transmitter, such as the first microphone transmitter 110, by issuing a command (e.g., a change channel command or a change transmit power command) to the microphone transmitter.

In a particular embodiment, the microphone receiver 130 maintains the signal power of each channel based on a comparison of a signal-to-noise ratio value to a signal-to-noise ratio threshold. For example, the signal quality module 138 may determine a signal-to-noise ratio value of an analog audio signal received at the microphone receiver 130 via an assigned audio frequency channel. The microphone receiver 130 may compare the signal-to-noise ratio value to a threshold. When the signal-to-noise ratio value is less than or equal to the threshold, the microphone receiver 130 may issue a command to a microphone transmitter, such as the first microphone transmitter 110, corresponding to an audio frequency channel via which the audio signal was received. The command may cause the microphone to adjust an output power level or change from the audio frequency channel to another audio frequency channel.

As another example, the signal quality module 138 may determine a noise power value of one or more audio frequency channels that the microphone receiver 130 is not assigned to receive and process audio signals from. The signal quality module 138 may determine a received signal strength value of a digital communication signal received at the microphone receiver 130 from another device via a particular digital control channel. The microphone receiver 130 may determine the received signal strength value of the digital communication from a particular device regardless of whether the microphone receiver 130 is assigned to process audio signals from the particular device. The digital communication signal may include a device identifier of the particular device and the signal quality module 138 may associate the received signal strength value with the device identifier of the particular device.

In a particular embodiment, the controller device 140 may periodically (e.g., every millisecond) receive digital signals for each device in the microphone system 100. The controller device 140 may also send digital signals more frequently or less frequently based on a determination of whether one or more devices in a particular area are in motion.

In order for the corrective actions (e.g., the commands 160) issued by the controller 144 to effectively reduce or eliminate the effects of intermodulation products, the microphone system 100 may include timing margins sufficient to enable the one or more devices of the microphone system 100 to respond to the commands 160 before intermodulation interference has a noticeable negative effect on the microphone system 100. For example, a particular device of the microphone system may be able to change an output power level or switch to another audio frequency channel in less than 500 microseconds (μs) after receiving the commands 160 from the controller 144.

In a particular embodiment, the controller 144 may initiate a command to adjust (e.g., change a power level or channel/frequency assignment) a setting of a single device. In another particular embodiment, the controller 144 may initiate a plurality of commands (e.g., the commands 160) to adjust (e.g., move) a group (e.g., a set or a cluster) of devices of the microphone system from their current channels to a group of consecutive channels within or next to an “IM dump frequency zone,” so that the intermodulation products generated by the group devices do not have a negative effect on one or more devices of the microphone system 100. The “IM dump frequency zone” may include a group of contiguous, unused frequency channels. To utilize the “IM dump frequency zone,” the controller 144 may maintain (e.g., keep) a number of channels available for IM dumping. In a particular exemplary embodiment, in order to enable IM dumping, the microphone system 100 may space channels 350 kHz apart, utilize 80% of the channels in the PWMS, and maintain 20% of the channels in reserve as the “1M dump frequency zones.”

One particular advantage provided by at least one of the disclosed embodiments is that the microphone system 100 may estimate intermodulation products in real-time (or near real-time) and take one or more actions to reduce or eliminate negative effects of the estimated intermodulation products that may be experienced by one or more devices within the microphone system 100. Further, the microphone system 100 may manage the estimated intermodulation products to provide a power efficiency for one or more devices and to provide a compact frequency spectrum that is managed to avoid, reduce, and eliminate intermodulation products.

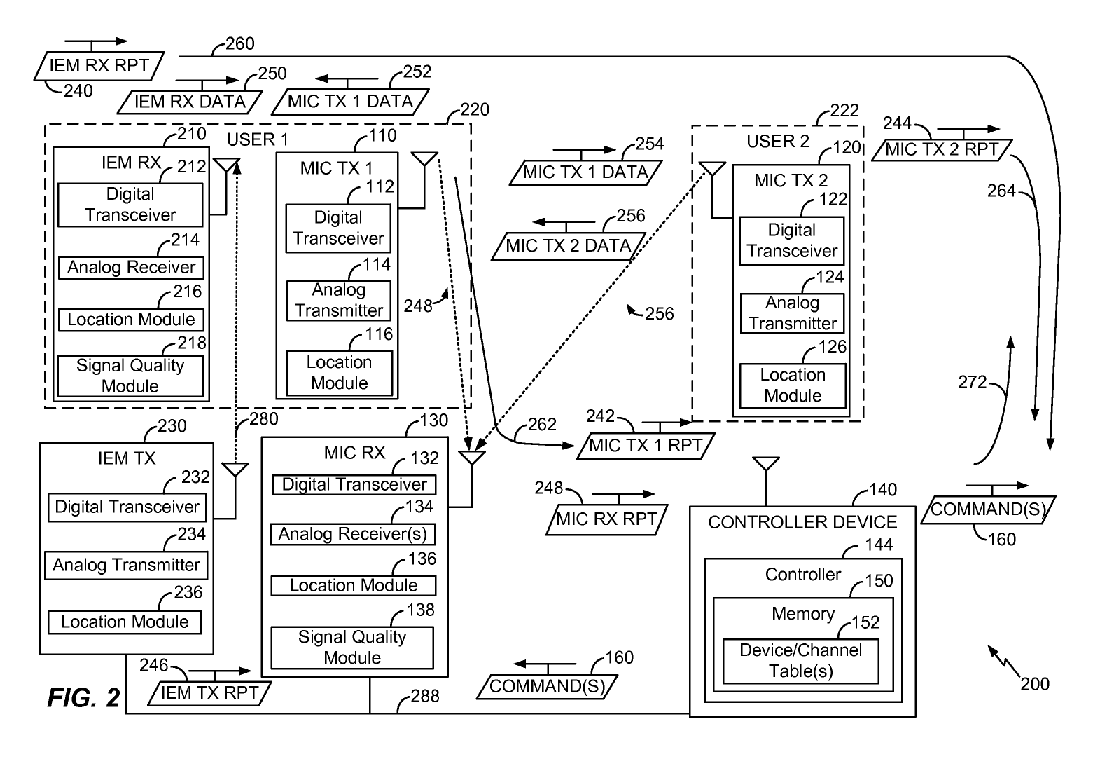

Referring to FIG. 2, a second particular embodiment of a microphone system 200 to control intermodulation products is shown. The microphone system 200 may include a plurality of devices, such as a first microphone transmitter (TX) 110, a second microphone transmitter 120, a microphone receiver (RX) 130, a control device 140, an in-ear monitor (IEM) receiver (RX) 210, and an IEM transmitter (TX) 230. In the microphone system 200, the IEM receiver 210 and the first microphone transmitter 110 may be associated with a first user 220 and the second microphone transmitter 120 may be associated with a second user 222. The plurality of devices may be wirelessly coupled to enable digital communications. Additionally, one or more devices, such as the IEM transmitter 230, the microphone receiver 130, and the controller device 140, may be coupled via a wired link.

The microphone system 200 may operate over a frequency spectrum that includes one or more audio frequency channels and one or more digital control channels (DCCh). An example of a frequency spectrum is described with respect to FIG. 4.

The IEM receiver 210 may include a digital transceiver 212, an analog receiver 214, a location module 216, and a signal quality module 218. The IEM receiver 210 may be configured to receive one or more audio signals (e.g., radio frequency (RF) signals) via an audio frequency channel and/or communicate other information (e.g., proximity information, control information, audio parameter information, etc.) via a digital control channel.

The IEM receiver 210 may receive one or more audio signals using the analog transmitter 214. The IEM receiver 210 may be assigned an audio frequency channel to receive the one or more audio signals. For example, the IEM receiver 210 may receive one or more audio signals sent by to the IEM transmitter 230 via a transmission path 280 using the audio frequency channel. The IEM receiver may receive a mix of audio signals from one or more microphone transmitters, such as the first microphone transmitter 110, the second microphone transmitter 120, or a combination thereof, based on a preference of a first user 220. For example, the IEM transmitter 230 may produce the mix of audio signals for the IEM receiver 210 based on one or more audio signals received at the IEM transmitter 230 from the microphone receiver 130 via a wired link 288.

In a particular embodiment, the analog receiver 214 of the IEM receiver 210 may be configured to change audio channels from a first audio channel to a second audio channel based on a command to change channels. For example, the IEM receiver 210 may include a dual reception capability (e.g., a make-before-break switchover) to enable the IEM receiver 210 to establish a communication link (e.g., a reception) via a first analog frequency channel prior to stopping (e.g., disconnecting) reception via a first analog frequency channel.

The signal quality module 218 of the IEM receiver 210 may be configured to determine signal quality data (e.g., a signal-to-noise ratio value, a noise power value, a received signal strength value, or a combination thereof) associated with one or more audio frequency channels used by the IEM receiver 210. For example, the signal quality module 218 may operate in a similar manner as the signal quality module 138 of the microphone receiver 130 of FIG. 1.

The IEM receiver 210 may transmit and/or receive one or more digital signals using the digital transceiver 212. The digital transceiver 212 of the IEM receiver 210 may operate in accordance with the digital transceiver 112 of the first microphone transmitter 110, the digital transceiver 122 of the second microphone transmitter 120, the digital transceiver 132 of the microphone receiver 130, or the digital transceiver 142 of the control device 140 of FIG. 1. The digital transceiver 212 may enable communication via a digital signal with one or more other devices included in the microphone system 200. The digital signals may include information communicated between the IEM transmitter 210 and one or more other devices of the microphone system 200, as described with respect to FIG. 5.

The location module 216 of the IEM receiver 130 may determine proximity data associated with one or more devices, such as the first microphone transmitter 110, the second microphone transmitter 120, the microphone receiver 130, and/or the IEM transmitter 230. The proximity data may indicate a relative location of each of one or more devices with respect to the IEM receiver 210. In a particular embodiment, the digital transceiver 112 may include the location module 216.

The location module 216 may initiate, via the digital transceiver 212, a search (e.g., a discovery procedure) for one or more devices of the microphone system 200. Based on a response from the one or more devices, the IEM receiver 210 may exchange data with the one or more devices to enable the IEM receiver 210 to determine proximity data (e.g., location information) for each device with respect to the IEM receiver 210. The data exchanged may also enable each of the one or more devices to determine corresponding proximity data with respect to the IEM receiver 210. For example, an exchange of data packets between the IEM receiver 210 and another device may enable the IEM receiver 210 and the other device to calculate a propagation delay based on when a first packet is sent from the IEM receiver 210 and received by the other device and when a second packet is sent from the other device and received by the IEM receiver 210. Based on the propagation delay, a distance between the IEM receiver 210 and the other device may be calculated.

For example, the IEM receiver 210 may initiate a search for the one or more devices and the first microphone transmitter 110 may respond. The IEM receiver 210 may send IEM data 250 to the first microphone transmitter 110, and the first microphone transmitter 110 may send first microphone transmitter data 252 to the IEM receiver 210. The IEM receiver 210 may determine proximity data with respect to the first microphone transmitter 110 and may associate the proximity data with the first microphone transmitter 110 based on an identifier of the first microphone transmitter 110. The IEM receiver 210 may obtain the identifier during communication with the first microphone transmitter 110. The identifier of the first microphone transmitter 110 may uniquely identify the first microphone transmitter 110 within the microphone system 200. In a particular embodiment, the identifier is a device identification (ID) of the first microphone transmitter 110. Additionally, the first microphone transmitter 110 may determine the proximity data with respect to the IEM receiver 210 and may associate the proximity data with the IEM receiver 210 based on an identifier of the IEM receiver 210.

The location module 216 may generate an IEM receiver report 240 that includes the proximity data associated with the first microphone transmitter 110, an identifier (e.g., a device ID) associated with the IEM receiver 210, an audio frequency channel assigned to the IEM receiver 210, the signal quality data determined by the signal quality module 218, or a combination thereof. The IEM receiver report 240 may also include additional information, as described with reference to FIG. 5. The digital transceiver 212 may transmit the IEM receiver report 240 to the control device 140 via a digital control channel. The IEM receiver report 240 may be transmitted to the control device 140 either directly or via one or more other devices (e.g., via a mesh network). In a particular embodiment, the IEM receiver report 240 is transmitted to the control device 140 via a path 260 that includes the first microphone transmitter 110 and the second microphone transmitter 120.

The IEM transmitter 230 may include a digital transceiver 232, an analog transmitter 234, and a location module 236. The digital transceiver 232 and the location module 236 of the IEM transmitter 230 may operate in a similar manner as the digital transceiver 112 and the location module 116 of the first microphone transmitter 110.

The IEM transmitter 230 may transmit one or more audio signals using the analog transmitter 234. The IEM transmitter 230 may be assigned an audio frequency channel to transmit the one or more audio signals. For example, the IEM transmitter 230 may transmit the one or more audio signals to the IEM receiver 210 via a transmission path 280 using the audio frequency channel.

The IEM transmitter 230 may communicate (e.g., transmit or receive) one or more digital signals using the digital transceiver 232. The digital transceiver 232 may communicate, via digital signals, with one or more other devices included in the microphone system 200. The digital signals may include information communicated between the IEM transmitter 230 and one or more other devices of the microphone system 200, as described with respect to FIG. 5.

The location module 236 may enable the IEM transmitter 230 to determine proximity data associated with the IEM transmitter 230. The IEM transmitter 230 may determine proximity data associated with the IEM transmitter 230 using the location module 236. For example, the location module 236 may initiate, via the digital transceiver 232, a search (e.g., a discovery procedure) for one or more devices of the microphone system 200. For example, the IEM transmitter 230 may transmit a beacon message including a device ID of the IEM transmitter 230. The device ID of the IEM transmitter 230 included in the beacon message may enable one or more devices to send a response message to the IEM transmitter 230. Based on a response message from the one or more devices, the IEM transmitter 230 may exchange data with the one or more devices. The exchanged data enables the IEM transmitter 230 to determine proximity data (e.g., location information) for each device with respect to the IEM transmitter 230. For example, the IEM transmitter 230 may exchange data with one or more other devices in a similar manner as the IEM receiver 210 exchanges data with another device to determine proximity data. The exchanged data may also enable each of the one or more devices to determine corresponding proximity data with respect to the IEM transmitter 230.

The location module 236 may generate an IEM transmitter report 246 that includes the proximity data associated with the IEM transmitter 230, an identifier (e.g., a device ID) associated with the IEM transmitter 230, an audio frequency channel assigned to the IEM transmitter 230, or a combination thereof. The IEM transmitter report 246 may also include additional information, as described with reference to FIG. 5. The IEM transmitter report 240 may be transmitted to the control device 140 wirelessly or via the wired connection 288.

The first microphone transmitter 110, using the location module 116, may determine proximity data with respect to the IEM receiver 210 based on data (e.g., the IEM data 250 and/or the first microphone transmitter data 252) exchanged between the IEM receiver 210 and the first microphone transmitter 110. The first microphone transmitter 110 may associate the proximity data with the IEM receiver 210 based on an identifier of the IEM receiver 210. The first microphone transmitter 110 may obtain the identifier of the IEM receiver 210 during communication with the IEM receiver 210.

The first microphone transmitter 110 may also initiate a search for one or more devices with which to obtain additional proximity data. The search for the one or more devices may identify the second microphone transmitter 120. The first microphone transmitter 110 may send first microphone transmitter data 254 to the second microphone transmitter 120, and the second microphone transmitter 120 may send second microphone transmitter data 256 to the first microphone transmitter 110. The first microphone transmitter data 254 may be the same data as the first microphone transmitter data 252, or the data 254 may be different data than the first microphone transmitter data 252. The first microphone transmitter 110 may determine proximity data with respect to the second microphone transmitter 120 and may associate the proximity data with the second microphone transmitter 120 based on an identifier of the second microphone transmitter 120. The identifier associated with the second microphone transmitter 120 may uniquely identify the second microphone transmitter 120 within the microphone system 200.

The location module 116 of the first microphone transmitter 110 may generate a first microphone transmitter report 242 that includes the proximity data associated with the second microphone transmitter 120, the proximity data associated with the IEM receiver 210, or a combination thereof. The first microphone transmitter report 242 may also include additional information, as described with reference to FIG. 5. The digital transceiver 112 of the first microphone transmitter 110 may transmit the first microphone transmitter report 242 to the control device 140 via a digital control channel. The first microphone transmitter report 242 may be transmitted to the control device 140 either directly or via one or more other devices (e.g., via a mesh network). In a particular embodiment, the first microphone transmitter report 242 is transmitted to the control device 140 via a path 262 that includes the microphone receiver 130.

Additionally, the location module 126 of the second microphone transmitter 120 may determine proximity data with respect to the first microphone transmitter 110 and may associate the proximity data with the first microphone transmitter 110 based on an identifier of the first microphone transmitter 110. The location module 126 of the second microphone transmitter 120 may generate a second microphone transmitter report 244 that includes the proximity data associated with the first microphone transmitter 110. The second microphone transmitter report 244 may also include additional information, as described with reference to FIG. 5. The digital transceiver 122 of the second microphone transmitter 120 may transmit the report 244 to the control device 140 via a digital control channel. In a particular embodiment, the report 244 may be transmitted to the controller device 140 via a transmission path 264.

The microphone receiver 130 may receive, via the analog receivers 134, and process audio signals from one or more microphone transmitters. For example, the microphone receiver may receive and process first audio signals 248 from the first microphone transmitter 110 and second audio signals form the second microphone transmitter 256. The signal quality module 138 of the microphone receiver 130 may determine signal quality data associated with one or more audio channels and one or more digital communications.

The location module 136 of the microphone receiver 130 may determine proximity data corresponding to the microphone receiver 120 with respect to one or more devices included in the microphone system 200. The location module 136 of the microphone receiver 130 may generate a microphone receiver report 248 (e.g., a message) that includes the proximity data associated with the microphone receiver 130, the signal quality data, additional information (as described with reference to FIG. 5), or a combination thereof. The digital transceiver 132 of the microphone receiver 130 may transmit the report 248 to the control device 140 via a digital control channel. The digital control channel used by the microphone receiver 130 may be the same digital control channel used by one or more other devices in the microphone system 200, or may be a different digital control channel.

The control device 140 may receive the reports from the one or more devices of the microphone system 200 and may update the device/channel tables 152 based on the received reports. For example, the controller 144 of the control device 140 may update the device/channel tables 152 to reflect proximity data included in each of the reports.

The device/channel tables 152 may include information indicating whether one or more devices of the microphone system 200 are priority devices. When a particular device is indicated as a priority device, the controller 144 may provide preference to (give priority to) the particular device when determining one or more corrective actions. For example, when a particular estimated intermodulation product indicates that a corrective action needs to be taken, such as changing an audio channel or adjusting (e.g., increase) a transmit power level of one or more devices, the controller may choose corrective actions affecting devices that are not indicated as priority devices. When a device implements a corrective action, such as changing audio channels or adjusting a transmit power level, the device expends energy which reduces a battery life of a power source (e.g., a battery) of the device. By selecting one or more devices other than the particular device indicated as the priority device, a battery life of a battery of the particular device is not reduced (e.g., shortened) because of the corrective action.

The controller 144 of the control device 140 may estimate one or more intermodulation products based on the information stored in the device/channel tables 152. For example, the controller 144 may estimate the intermodulation products based at least in part on the proximity data stored in the device/channel tables 152. The controller 144 may determine a whether a particular estimated intermodulation product affects an audio signal transmitted or received by a particular device of the microphone system 100. For example, the controller 144 may determine that a particular estimated intermodulation product affects the particular device when a frequency of the estimated intermodulation product is the same as a radio frequency (RF) carrier frequency of the audio signal transmitted by the particular device and when a value of the estimated intermodulation product is greater than or equal to a threshold. When a determination is made that the particular estimated intermodulation product affects the particular device, the controller may generate one or more commands 160 associated with a corrective action to reduce or eliminate the estimated intermodulation product that affects the particular device. The controller 144 may initiate transmission of the one or more commands 160 to at least one device of the microphone system 200. For example, the controller may transmit the commands 160 via a wireless transmission path 272, via a wired network (e.g., a wired transmission path), or a combination thereof.

During operation of the microphone system 200, one or more devices of the microphone system 200 may generate a corresponding report that is sent to the controller device 140. For example, each of the IEM receiver 210, the first microphone transmitter 110, the second microphone transmitter 120, the IEM transmitter 230, and the microphone receiver 130 may generate a corresponding report. Each report may include proximity data associated with a device that generated the report. The reports may be transmitted to the controller device via one or more digital control channels.

The control device 140 may receive the reports from the one or more devices of the microphone system 200 and may update the device/channel tables 152 based on the received reports. The controller 144 of the control device 140 may estimate one or more intermodulation products based on proximity data included in the received reports, the device/channel tables 152, or a combination thereof.

The controller 144 may determine a whether a particular estimated intermodulation product affects an audio signal transmitted or received by a particular device of the microphone system 100. When the controller 144 determines that the particular estimated intermodulation product affects the particular device, the controller 144 generates one or more commands 160 associated with a corrective action to reduce or eliminate the estimated intermodulation product that affects the particular device. The controller 144 may initiate transmission of the one or more commands 160 to at least one device of the microphone system 200. For example, the controller may transmit the commands 160 via a wireless transmission path 272, via a wired network (e.g., a wired transmission path), or a combination thereof. After the commands 160 are executed (i.e., corrective action is taken) by the one or more devices, the estimated intermodulation product affecting the particular device may be reduced or eliminated.

Referring to FIG. 3, tables (e.g., illustrative data structures) utilized by a controller of a microphone system are shown. For example, data formatted in accordance with the data structures may be stored at the memory 150 (e.g., in the device/channel tables 152) and utilized by the controller 144 of the control device 140 of FIG. 1. Although illustrative tables are shown in FIG. 3, other data structures may be utilized.

A first table 300 illustrates data to identify and track one or more devices in a microphone system, such as devices in the microphone system 100 of FIG. 1 or the microphone system 200 of FIG. 2. The first table 300 includes columns indicating a device identification (ID) 310, a device priority 312, allocated channel(s) 314, a transmission power level 316, and proximity data 318. The first table 300 may also include one or more entries that are each associated with the microphone system. For example, each entry may correspond to a device of the microphone system identified (e.g., detected) by and registered with the controller of the microphone system. Illustrated entries correspond to a first microphone transmitter (MIC TX-1), a second microphone transmitter (MIC TX-2), a first microphone receiver (MIC RX-1), and a first in-ear monitor transmitter (IEM TX-1). For the entry corresponding to the first microphone transmitter (MIC TX-1), the device priority 312 indicates that a first microphone transmitter is a priority device, the allocated channel 314 indicates that the audio frequency channel is allocated to the first microphone transmitter (MIC TX-1), and the power level 316 indicates that a transmit power level of the first microphone transmitter (MIC TX-1) is forty decibel (dB). The proximity data 318 for the first microphone transmitter (MIC TX-1) indicates a relative location of each of three devices (e.g., a first in-ear monitor receiver (IEM RX-a), the first in-ear monitor transmitter (IEM TX-1), and the first microphone receiver (MIC RX-a)) with respect to the first microphone transmitter (MIC TX-1).

A second data table 370 illustrates data to identify and track one or more channel allocations in the microphone system. For example, the second table 370 may be associated with a microphone receiver, such as the microphone receiver 130 of FIG. 1, and may include one or more channels capable of being received by the microphone receiver. The second table 370 may include columns indicating a channel 380, a device identifier (ID) 382, and a signal-to-noise ratio (SNR) value/noise value 384. The second table 370 may also include one or more entries that are each associated with a channel of the microphone system. Illustrated entries correspond to channels 1-4. For the entry corresponding to channel 1, the device ID 382 indicates channel one (1) is allocated to the first microphone transmitter (TX-1), and the signal-to-noise ratio (SNR) value/noise value 384 indicates the microphone receiver that receives one or more audio signals via channel one has calculated a signal-to-noise ratio (SNR) value of 98 dB. For the entry corresponding to channel 2, the device ID 382 indicates channel two (2) is not allocated to a device, and the signal-to-noise ratio (SNR) value/noise value 384 indicates that the microphone receiver has detected 10 dB of noise on channel 2.

Referring to FIG. 4, an illustrative embodiment of a frequency spectrum 400 of a microphone system is shown. For example, the frequency spectrum 400 may be utilized by the microphone system 100 of FIG. 1 or the microphone system 200 of FIG. 2. In a particular embodiment, the frequency spectrum 400 illustrates channel allocations and receiver impairments of a digitally controlled analog system.

The frequency spectrum 400 of the microphone system may be configured such that audio channels (e.g., analog audio channels) are allocated over a first portion 402 of the frequency spectrum 400. In a particular embodiment, the first portion 402 may include a bandwidth between 790 Megahertz (MHz) and 799 MHz. The audio channels may be spaced every 300-400 kilohertz (kHz) per carrier within the first portion 402 of the frequency spectrum of the microphone system, such as the microphone system 100 of FIG. 1 or the microphone system 200 of FIG. 2. For example, the first microphone transmitter 110, the second microphone transmitter 120, the microphone receiver 130 of FIG. 1, the IEM receiver 210, or the IEM transmitter 230 of FIG. 2 may communicate audio frequency signals via the audio channels allocated over the first portion 402 of the frequency spectrum 400. The bandwidth of the first portion 402 may also include an “IM dump frequency zone” that is maintained by a controller, such as the controller 144 of FIG. 1. The “IM dump frequency zone” may include a group of contiguous, unused frequency channels that the controller may assign to a group of devices as part of a corrective action to reduce or eliminate intermodulation products. In a particular embodiment, frequency carriers (used and unused) are equally spaced every 350 kHz.

A second portion 404 of the frequency spectrum 400 is allocated to digital control channels 420 of the microphone system. As shown in FIG. 4, the second portion 420 may include a bandwidth between 810 Megahertz (MHz) and 830 MHz. Alternatively or in addition to, the second portion 420 may include an 800 megahertz (MHz) frequency band, a 900 MHz frequency band, or another frequency band. The second portion 404 of the frequency spectrum 400 may be used by one or more devices of the microphone system to exchange information, as described further with respect to FIG. 5. For example, the one or more devices may include the first microphone transmitter 110, the second microphone transmitter 120, the microphone receiver 130, the control device 140 of FIG. 1, or the IEM receiver 210 or the IEM transmitter 230 of FIG. 2. Each device of the microphone system may communicate digital signals to one or more other devices of the microphone system via one or more digital control channels of the second portion 404.

Referring to FIG. 5, a particular illustrative embodiment of information that may be communicated in digital communications, via one or more digital control channels, between different devices in a microphone system 500 is shown. The microphone system 500 may include or correspond to the microphone system 100 of FIG. 1, the microphone system 200 of FIG. 2, or combinations thereof.

The microphone system 500 includes a plurality of devices, such as an IEM receiver 502 (or IEM transmitter), a controller 504, a microphone receiver 506 and a microphone transmitter 508. Each device of the plurality of devices may communicate (e.g., send and receive) digital signals including information via one or more digital control channels to one or more devices of the microphone system 500. The digital communications may include messages (e.g., reports), commands, or a combination thereof. Each device of the plurality of devices may also be configured to forward a digital communication from a first device to a second device. For example, the microphone receiver 506 may forward a digital communication from the microphone transmitter 508 to the controller 504.

The IEM receiver 502 may be configured to communicate information 510 to one or more devices of the microphone system 500. The information 510 may include signal quality information, such as signal to noise information, signal strength information (e.g., RSSI), frequency or channel information, proximity information, power report information, and dual frequency receiver information. During operation of the microphone system 500, the IEM receiver 502 may send a digital communication 550 that includes at least a portion of the information 510 to the controller 504. For example, the digital communication may be transmitted via one or more digital control channels.

The controller 504 may be configured to communicate information 520, 522 to one or more devices of the microphone system 500. The information 520 may include one or more of microphone admission control information, microphone channel assignment information, microphone control information, digital control channel relay information, microphone receive power target information, dual frequency transmitter information, or a combination thereof. During operation of the microphone system 500, the controller 504 may send a digital communication 554 that includes at least a portion of the information 520 to the microphone receiver 506. The information 520 may include IEM channel assignment information, dual-frequency receiver information, or a combination thereof. During operation of the microphone system 500, the controller 504 may send a digital communication 552 that includes at least a portion of the information 522 to the IEM receiver 502 (or the IEM transmitter).

The microphone receiver 506 may be configured to communicate information 530, 532 to one or more devices of the microphone system 500. The information 530 may include enable or disable information, microphone power command information, microphone channel/frequency change information, or dual frequency transmit command information. During operation of the microphone system 500, the microphone receiver 506 may send a digital communication 558 that includes at least a portion of the information 530 to the microphone transmitter 508. The information 532 may include channel power measurement information, signal and noise measurement information, microphone digital control channel power measurement information, interference measurement information measurement, or a combination thereof. The information 532 also includes microphone adjustment control information, microphone channel assignment information, or microphone proximity report information. During operation of the microphone system 500, the microphone receiver 506 may send a digital communication 556 that includes at least a portion of the information 532 to one or more devices of the microphone system, such as the controller 504.

The microphone transmitter 508 may be configured to communicate information 540 to one or more devices of the microphone system 500. The information 540 may include a device identifier, enable/disable information, power report information, proximity report information, channel or frequency information, dual frequency transmit information, or a combination thereof. During operation of the microphone system 500, the microphone transmitter 508 may send a digital communication 560 that includes at least a portion of the information 540 to one or more devices of the microphone system, such as the microphone receiver 506 or the controller 504.

During operation, the microphone transmitter 508 may take action in response to receiving commands or messages. For example, the microphone transmitter 508 may perform a power adjustment action 542 in response to receiving a message (e.g., a command) from the microphone receiver 506 or the controller 504. For example, in response to receiving the digital communication 558 from the microphone receiver 506, the microphone transmitter 508 may take an action to control a power level, such as a power adjustment action 542. The power adjustment action 542 may reduce or increase power of signals transmitted by the microphone transmitter 508.

The controller 504 may send one or more commands (e.g., one or more messages, such as the digital communications 554 and 552) to various devices, (e.g., to the microphone receiver 506, the microphone transmitter 508, the IEM receiver 502, or the IEM transmitter). In response to such commands, the receiving device (e.g., microphone receiver 506, the microphone transmitter 508, the IEM receiver 502, or the IEM transmitter) may take actions. Such actions include corrective actions determined by the controller 504. Corrective actions may be determined by the controller 504 in response to the controller 504 estimating intermodulation products or performing interference calculations.

Thus, the information communicated via one or more digital control channels, illustrated by the system 500, may be used by a microphone system to communicate proximity information, signal quality information, and command and control information in order to dynamically make adjustments to device settings based on various environmental factors such as estimated intermodulation products and interference.

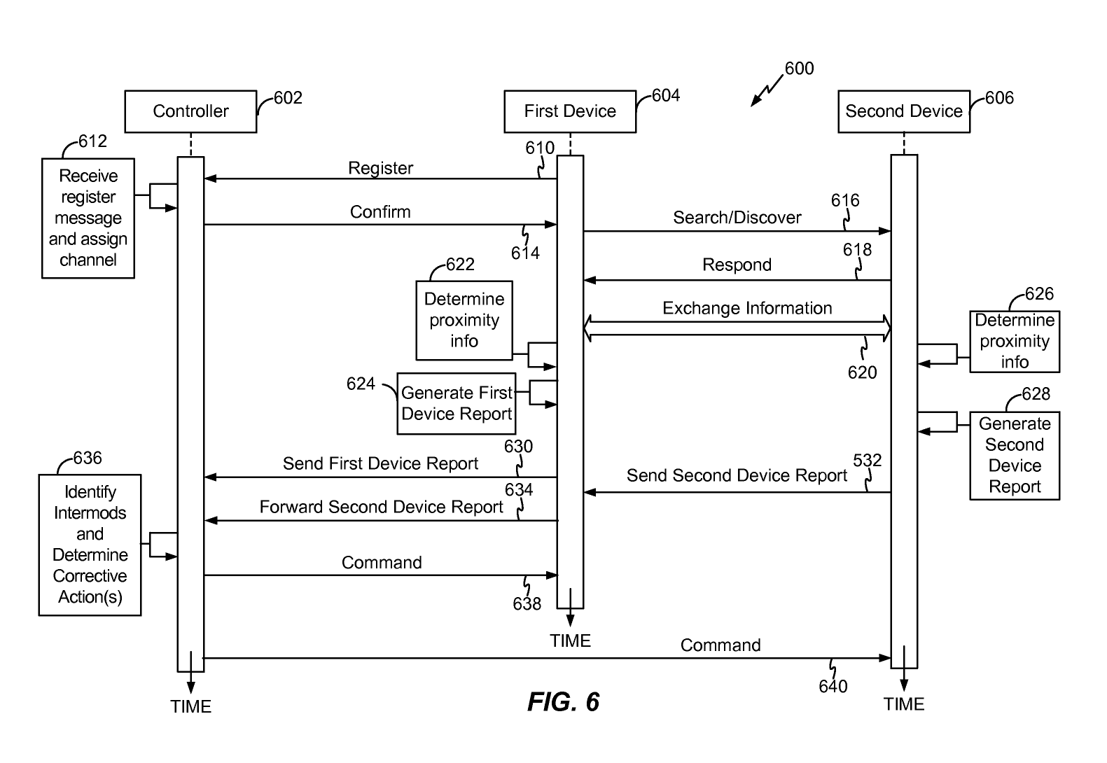

FIG. 6 is a ladder diagram 600 that illustrates a method to communicate proximity data to a controller of a microphone system. The microphone system may include the microphone system 100 of FIG. 1, the microphone system 200 of FIG. 2, the microphone system 500 of FIG. 5, or combinations thereof.

The microphone system includes a controller 602, a first device 604, and a second device 606. For example, the controller 602 may correspond to the controller 144 of FIG. 1 or the controller 504 of FIG. 5. The first device 604 and the second device 606 may each correspond to one of the first microphone transmitter 110, the second microphone transmitter 120, the microphone receiver 130, the control device 140 of FIG. 1, the IEM receiver 210, the IEM transmitter 230 of FIG. 2, the IEM receiver/IEM transmitter 502, the controller 504, the microphone receiver 506, or the microphone transmitter 508 of FIG. 5. Each of the controller 602, the first device 604, and the second device 606 may be configured to communicate (e.g., send and receive digital signals) via one or more digital channels.

The first device 604 may send a register message to the controller 602, at 610. For example, the register message may indicate that the first device 604 requests to register with the microphone system associated with the controller 602. The register message may include a device identifier (ID) of the first device 604 that uniquely identifies the first device 604. In a particular embodiment, the register message may include any of the information 510, 532, 540 of FIG. 5.

The controller 602 may receive the register message and assign an audio channel to the first device 604, at 612. When the controller 602 receives the register message from the first device 604, the controller 602 may store data in a memory (e.g., populate at least one entry in a data structure, such as the device/channel tables 152 of FIG. 1, the data structure 300, or the data structure 370 of FIG. 3). The audio channel assigned to the first device 604 may be utilized by the first device 604 to send or receive one or more analog audio signals.

The controller 602 may send a confirmation message to the first device 604, at 614. The confirmation message may indicate that the first device 604 is registered with the controller 602 and may identify the audio channel assigned to the first device 604. The confirmation message may also include any of the information 520, 522 of FIG. 5.

The first device 604 may send a search/discovery message, at 616. The search/discovery may include the device ID of the first device 604. The search/discovery message may be received by the second device 606. In a particular embodiment, the second device 606 may be registered with the controller 602. The second device 606 may send a response message to the first device, at 618. The response message may identify the second device 606 to the first device 604.

The first device 604 and the second device 606 may establish a communication link (e.g., a digital communication link) and may exchange information, at 620. The information exchanged between the first device 604 and the second device 606 may enable the first device 604 to determine proximity information associated with the first device 604, at 622, and may enable the second device 606 to determine proximity information associated with the second device 606, at 626. For example, the first device 604 and the second device 606 may determine proximity information based on a propagation delay between messages communicated between the first device 604 and the second device 606.

The proximity information associated with the first device 604 may indicate a relative location of the second device 606 with respect to the first device 604. For example, the proximity information associated with the first device 604 may include the first microphone transmitter proximity data 102, the second microphone transmitter proximity data 104, or the microphone receiver proximity data 106 of FIG. 1. The proximity information associated with the second device 606 may indicate a relative location of the first device 604 with respect to the second device 606. For example, the proximity information associated with the second device 606 may include the first microphone transmitter proximity data 102, the second microphone transmitter proximity data 104, or the microphone receiver proximity data 106 of FIG. 1.

The first device 604 may generate a first device report, at 624. For example, the first device report may include the IEM receiver report 240, the first microphone transmitter report 242, the second microphone transmitter report 244, the IEM transmitter report 246, or the microphone receiver report 248 of FIG. 2. The first device report may include the proximity information associated with the first device 604 and any of the information 510, 532, 540 of FIG. 5. The first device 604 may send the first device report to the controller 602, at 630.

The second device 606 may generate a second device report, at 628. For example, the second device report may include the IEM receiver report 240, the first microphone transmitter report 242, the second microphone transmitter report 244, the IEM transmitter report 246, or the microphone receiver report 248 of FIG. 2. The second device report may include the proximity information associated with the second device 606 and any of the information 510, 532, 540 of FIG. 5. The second device 606 may send the second device report to the first device 604, at 532. The first device 604 may forward the second device report, or a portion thereof, to the controller 602, at 634.

The controller 602 may estimate intermodulation products and may determine one or more corrective actions, at 636. For example, the controller 602 may estimate which transmitter devices (e.g., a group of transmitters) create intermodulation products and the frequency and levels (e.g., power levels) of those estimated intermodulation products. The controller 602 may determine the estimated intermodulation products based on proximity data, radio frequency (RF) carrier frequencies, power levels, circuit characterizations (e.g., antenna gain or reverse third order intercept point characteristics), or a combination thereof, of the group of transmitter devices. Additionally, statistical factors (e.g., factors accounting for fading or shadowing) may be used by the controller 602 to determine the estimated intermodulation products or to calculate one or more errors (e.g., a tolerance) associated with the estimated intermodulation products. When a particular estimated intermodulation product exceeds a first threshold (or satisfies a controller criteria for taking a corrective action), the controller may determine one or more corrective actions to manage (e.g., reduce or eliminate) the particular estimated intermodulation product. The threshold may include a single value or a range of values. The controller criteria may be defined or programmed by a user or administrator of the microphone system.

The controller 602 may also determine whether the particular estimated intermodulation product has a frequency (e.g., a RF carrier frequency) corresponding to a channel (e.g., an unallocated channel or an allocated channel) of the microphone system. When the particular estimated intermodulation product has a frequency that is the same as a radio frequency (RF) carrier frequency of an unallocated channel (e.g., a channel not assigned to a device of the microphone system 600), the controller 602 may not determine one or more corrective actions. When the particular estimated intermodulation product has a frequency that is the same as an RF carrier frequency of an allocated channel (e.g., a channel assigned to a particular device of the microphone system), the controller 602 may determine whether the estimated intermodulation product will degrade a signal that occupies the RF carrier frequency of the allocated channel associated with the particular device.

The controller 602 may determine whether the signal transmitted by the particular device is degraded based on a proximity of the particular device to a transmitter device that generates the particular estimated intermodulation product. For example, the controller 602 may determine whether the particular device is close enough (e.g., physically) to the transmitter device based on the proximity data associated with the two or more transmitter devices and the proximity data associated with the particular device.

Further, the controller 602 may determine whether the signal transmitted by the particular device is degraded by the particular estimated intermodulation product based on a proximity of (e.g., a distance between) the transmitter device that generates the particular estimated intermodulation product and a receiver device that receives the signal transmitted by the particular device. Based on the proximity of the transmitter device to the receiver device, the controller 602 may determine an estimated signal propagation loss of the particular estimated intermodulation product generated by the transmitter device and may determine an intermodulation level of the particular estimated intermodulation product at the receiver device. The controller 602 may also compute a signal-to-noise ratio based on a signal strength of the signal generated by the particular device and received by the receiver device and compare the signal-to-noise ratio to a threshold signal-to-noise ratio value. The controller 602 may determine that the signal transmitted by the particular device is degraded by the particular estimated intermodulation product when the signal-to-noise ratio is greater than the threshold signal-to-noise ratio value and when the intermodulation level is greater than zero. In a particular embodiment, when the signal-to-noise ratio is greater than the threshold signal-to-noise ratio value, the controller 602 may determine a difference between the signal-to-noise ratio and the threshold signal-to-noise ratio value. The controller 602 may determine that the signal transmitted by the particular device is degraded by the particular estimated intermodulation product when the difference between the signal-to-noise ratio and the threshold signal-to-noise ratio value is less than the intermodulation level.

In a particular embodiment, the controller 602 determines that the signal transmitted by the particular device is degraded based on a comparison of the estimated intermodulation product to a second threshold. The controller 602 may determine that the signal transmitted by the particular device is degraded when the estimated intermodulation product is greater than or equal to the second threshold. Additionally, the controller 602 may perform the comparison when an average distance between one or more devices in the microphone system is less than a threshold distance.

When the controller 602 determines that the signal generated by the particular device is degraded, the controller 602 may determine one or more corrective actions to manage (e.g., reduce or eliminate) the particular estimated intermodulation product. For example, the controller 602 may determine to reduce a transmit power of the transmitter device corresponding to the particular intermodulation product, increase a transmit power of the particular device, change a channel allocation of the particular device, or a combination thereof.

The controller 602 may send a first command to the first device 604, at 638, and the controller 602 may send a second command to the second device 606, at 640. The first command and the second command may be associated with the corrective action identified by the controller. For example, when the first command is executed by the first device 604 and the second command is executed by the second device 606, the particular estimated intermodulation product may be reduced or eliminated. The first command and the second command may correspond to the commands 160 of FIG. 1 and may include any of the information 520, 522, 530 of FIG. 5.

In an illustrative example of the system 600 of FIG. 6, the controller may register the first device 604 and the second device 606. The controller 602 may receive the first device report and the second device report from the first device 604 and the second device 606, respectively. In the example, based on registering the first device 604 and the second device 606, the received first device report, the received second device report, or a combination thereof, the controller 602 may determine that the first device 604 and the second device 606 are one meter apart, the first device 604 transmits a first signal at 5 dBm via an 800 MHz channel, the second device 606 transmits a second signal at 10 dBm via an 801 MHz channel, antenna gains of the first device 604 and the second device 606 are −2 dBi, and reverse IP3 of power amplifier and other circuitry of the first device 604 and the second device 606 (based on design specifications) is +20 dBm.

The controller 602 may estimate intermodulation products including a frequency (e.g., a RF carrier frequency) and a power level for each of the first device 604 and the second device 606. In a particular embodiment, the controller 602 may determine the intermodulation products using a propagation loss of 25 dB which is based on a radio frequency propagation at 800 Mhz and antenna gains of the first device 604 and the second device 606. For example, the controller 602 may determine (e.g., estimate) that the first device 604 generates a first estimated intermodulation product of −45 dBm at 799 MHz and a second estimated intermodulation product of −65 dBm at 802 MHz. The controller 602 may also determine estimated intermodulation products for the second device 606. Although the microphone system of FIG. 6 shows two devices, it will be appreciated that the microphone system may include more than two devices and the controller may determine estimated intermodulation products at each device based on a combination of two or more devices of the microphone system.

The controller 602 may determine whether one or more of the estimated intermodulation products occur (e.g., exist) on a frequency that is allocated (e.g., occupied) by another device. For example, the controller 602 may determine whether a particular device occupies a 799 MHz frequency at which the first estimated intermodulation product of −45 dBM is generated by the first device 604. When the controller determines that the 799 MHz frequency is allocated to the particular device, the controller determines whether the first estimated intermodulation product of −45 dBm at 799 MHz degrades a signal transmitted by the particular device. The controller 602 may determine whether the signal transmitted by the particular device is degraded based on a proximity of the particular device to the first device 604, a calculated (e.g., an estimated) intermodulation level of the first estimated intermodulation product experienced at a receiver device, a signal-to-noise ratio of the signal received by the receiver device, a comparison of the first estimated intermodulation product to one or more threshold values, or a combination thereof. When the controller 602 makes a determination that the signal transmitted by the particular device is degraded by the first estimated intermodulation product, the controller may determine one or more corrective actions to manage (e.g., reduce or eliminate) the effects of the first estimated intermodulation product on the signal transmitted by the particular device.

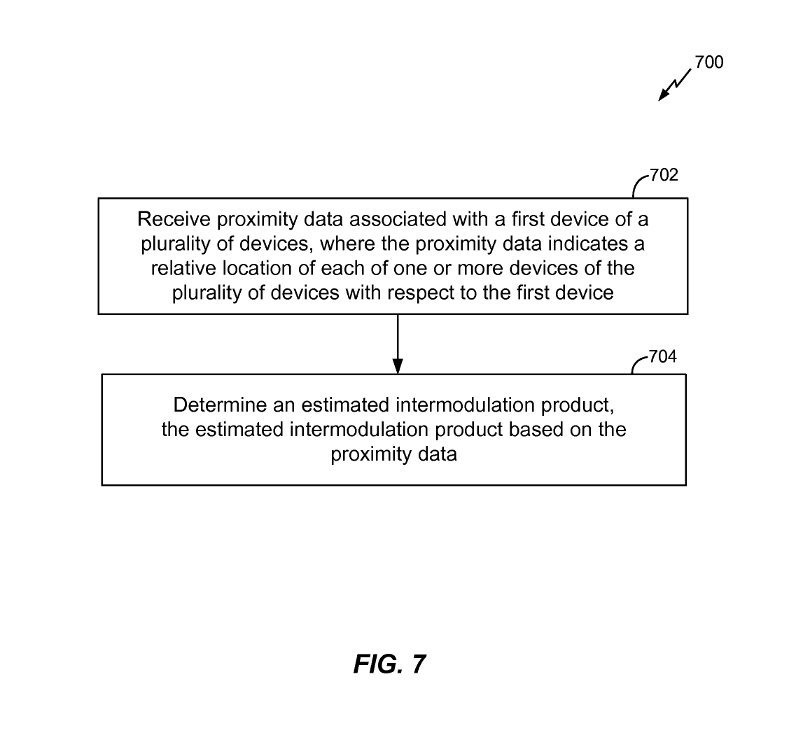

Referring to FIG. 7, a flow diagram of a first illustrative embodiment of a method 700 to operate a controller of a microphone system is illustrated. For example, the controller may include the controller 144 of FIG. 1, the controller 504 of FIG. 5, or the controller 602 of FIG. 2.

Proximity data associated with a first device of a plurality of devices is received, at 702. The proximity data indicates a relative location of each of one or more devices of the plurality of devices with respect to the first device. The relative location of each of the one or more devices may correspond to a distance between each of the one or more devices with respect to the first device. The plurality of devices may include the first microphone transmitter 110, the second microphone transmitter 120, the microphone receiver 130, the control device 140 of FIG. 1, the IEM receiver 210, the IEM transmitter 230 of FIG. 2, the IEM receiver/IEM transmitter 502, the controller 504, the microphone receiver 506, the microphone transmitter 508 of FIG. 5, the first device 604, or the second device 606 of FIG. 6.

An estimated intermodulation product is determined, at 704. The estimated intermodulation product is determined by the controller based on the proximity data.

In a particular embodiment, one or more commands may be transmitted to at least one device of the plurality of devices. The one or more commands may be based on an the estimated intermodulation product. For example, when the estimated intermodulation product exceeds a threshold, one or more corrective actions may be identified to alleviate (e.g., reduce or eliminate) the estimated intermodulation product. The one or more commands may correspond to at least one corrective action.

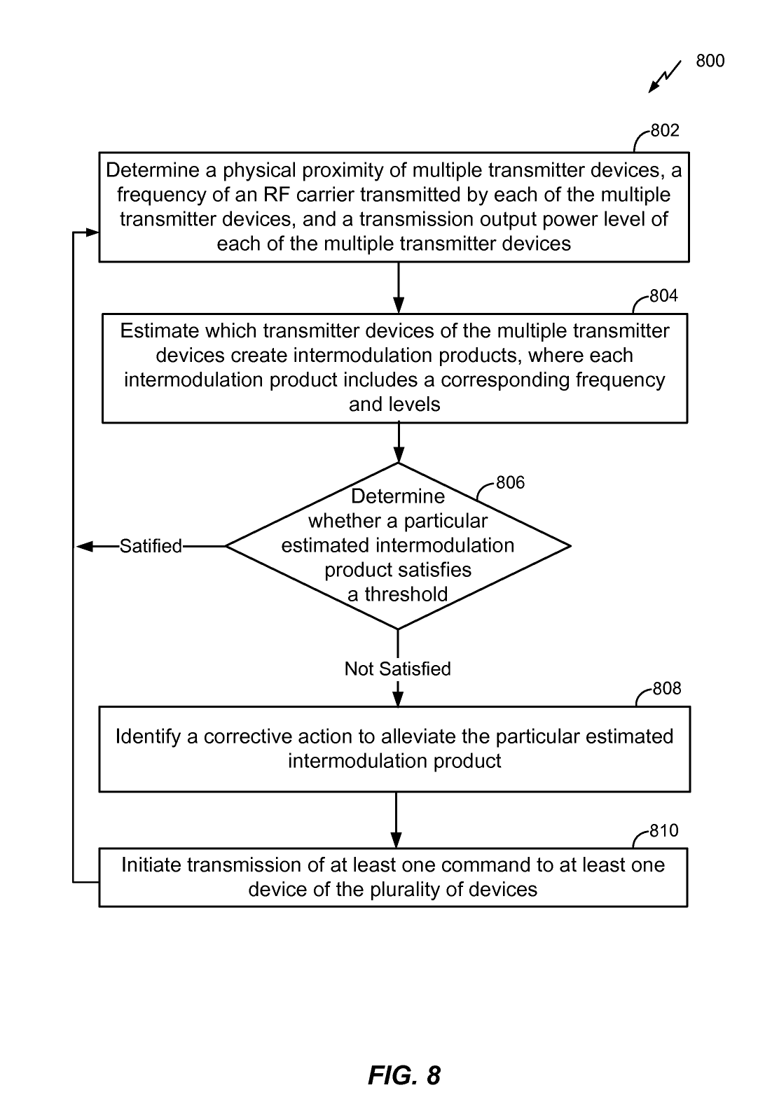

Referring to FIG. 8, a particular illustrative embodiment of a method 800 to operate a controller of a microphone system is shown. For example, the controller may include the controller 144 of FIG. 1, the controller 504 of FIG. 5, or the controller 602 of FIG. 6.

The method 800 includes determining a physical proximity of multiple transmitter devices, determining a frequency of an RF carrier transmitted by each of the multiple transmitter devices, and determining a transmission output level of each of the multiple transmitter devices, at 802. The multiple transmitter devices may include the first microphone transmitter 110, the second microphone transmitter 120 of FIG. 1, the microphone transmitter 508 of FIG. 5, the first device 604, the second device 606 of FIG. 6, or a combination thereof.

The method 800 further includes estimating which transmitter device of the multiple transmitter devices creates intermodulation products. Each intermodulation product includes a corresponding frequency and a corresponding level, at 804.

The method determines whether a particular intermodulation product satisfies a threshold, at 806. The particular intermodulation product may have an associated power and may be at a frequency (e.g., an RF carrier frequency) corresponding to a channel (e.g., an unallocated channel or a channel allocated to a device) of the microphone system. In a particular embodiment, the estimated intermodulation product may not satisfy the threshold when a value of the estimated intermodulation product is greater than or equal to the threshold. If the estimated intermodulation product not satisfies the threshold, at 806, the method proceeds to 808 to identify a corrective action to alleviate (e.g., reduce or eliminate) the particular estimated intermodulation product. The method 800 initiates transmission of at least one command to one or more devices of the plurality of devices, at 810. If the estimated intermodulation product does satisfy the threshold, at 806, the method ends and no action is taken.

In a particular embodiment, the determination, at 806, is conditioned on the frequency of the particular intermodulation product being the same as a frequency of an allocated channel of the microphone system since, if a channel (e.g., a frequency carrier) is not allocated to (e.g., occupied by) a device of the microphone system, the particular intermodulation product does not negatively impact performance of the microphone system.

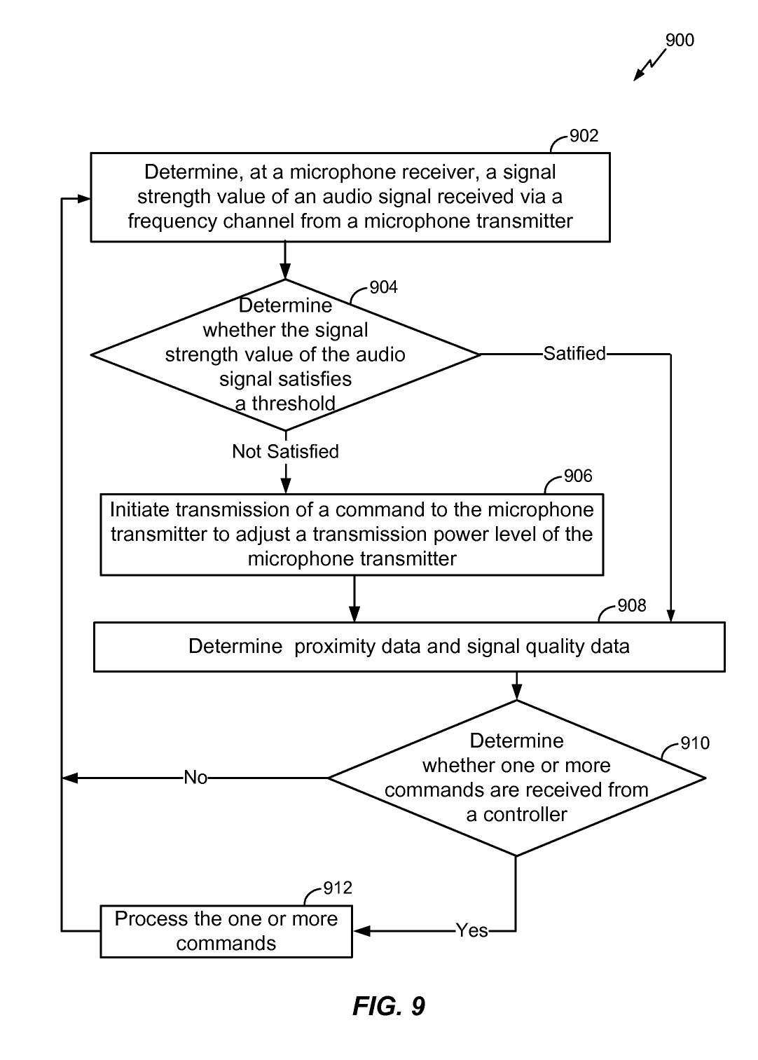

Referring to FIG. 9, a particular illustrative embodiment of a method 900 to operate a microphone receiver is illustrated. The microphone receiver may include the microphone receiver 130 of FIG. 1, the microphone receiver 506 of FIG. 5, the first device 604, or the second device 606 of FIG. 6.

The method 900 includes determining, at the microphone receiver, a signal strength value of an audio signal received via a channel, at 902. The audio signal is received at the microphone receiver from a microphone transmitter. The microphone transmitter may include the first microphone transmitter 110, the second microphone transmitter 120 of FIG. 1, the microphone transmitter 508 of FIG. 5, the first device 604, or the second device 606 of FIG. 6

The method determines whether the signal strength value of the audio signal satisfies a threshold, at 904. In a particular embodiment, the signal strength value may satisfy the threshold when the signal strength value is greater than or equal to the threshold. If the signal strength value of the audio signal satisfies the threshold, then the method proceeds to determine proximity data and signal quality data, at 908. If the signal strength value of the audio signal does not satisfy the threshold, then the method initiates transmission of a command to the microphone transmitter to adjust a transmission power level of a microphone transmitter, at 906, and determines the proximity data and signal quality data, at 908.

The method determines whether one or more commands are received from a controller at 910. For example, the controller may include the controller 144 of FIG. 1, the controller 504 of FIG. 5, or the controller 602 of FIG. 2. If one or more commands are received from the controller, then the method proceeds to receive one or more commands, at 912. Alternatively, if no commands are received from the controller, at 910, then the method is completed.

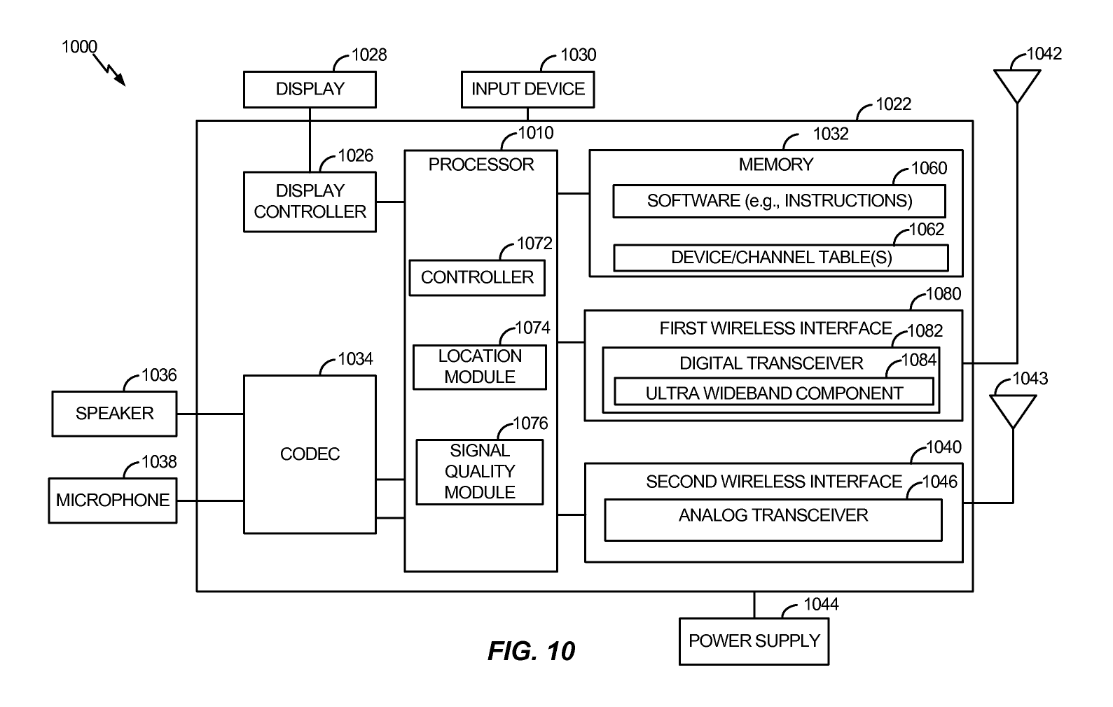

The method 600 of FIG. 6, the method 700 of FIG. 7, the method 800 of FIG. 8, the method 900 of FIG. 9, or any combination thereof, may be implemented or otherwise performed by a field-programmable gate array (FPGA) device, an application-specific integrated circuit (ASIC), a processing unit such as a central processing unit (CPU), a digital signal processor (DSP), a controller, another hardware device, a firmware device, or any combination thereof. As an example, at least a portion of any of the method 600 of FIG. 6, the method 700 of FIG. 7, the method 800 of FIG. 8, the method 900 of FIG. 9, or any combination thereof, may be implemented by a processor 1010 that executes instructions stored in a memory 1032, as described with respect to FIG. 10.

FIG. 10 is a block diagram of a particular embodiment of a device 1000 (e.g., a communication device) included in a microphone system, such as the microphone system 100 of FIG. 1, the microphone system 200 of FIG. 2, the microphone system 500 of FIG. 5, the microphone system 600 of FIG. 6, or a combination thereof. The device 1000 may be a wireless electronic device and may include a processor 1010, such as a digital signal processor (DSP), coupled to a memory 1032.

The processor 1010 may be configured to execute software 1060 (e.g., a program of one or more instructions) stored in the memory 1032. The memory may also store device/channel table(s) 1062, such as the device/channel tables 152 of FIG. 1, the first table 300, or the second table 370 of FIG. 3. The processor 1010 may include a controller 1072, a location module 1074, and a signal quality module 1076. For example, the controller 1072 may include or correspond to the control device 140, the controller 144 of FIG. 1, the controller 504 of FIG. 5, the controller 602 of FIG. 6, or a combination thereof. The location module 1074 may include or correspond to the location module 116 of the first microphone transmitter 110, the location module 126 of the second microphone transmitter 120, the location module 136 of the microphone receiver 130 of FIG. 1, the location module 216 of the IEM receiver 210, or the location module 236 of the IEM transmitter 230 of FIG. 2. The signal quality module 1076 may include or correspond to the signal quality module 138 of the microphone receiver 130 of FIG. 1.

In a particular embodiment, the processor 1010 may be configured to execute computer executable instructions 1060 stored at a non-transitory computer-readable medium, such as the memory 1032. The instructions are executable to cause a computer, such as the processor 1010, to perform at least a portion of any of the method 600 of FIG. 6, the method 700 of FIG. 7, the method 800 of FIG. 8, the method 900 of FIG. 9, or any combination thereof. For example, the computer executable instructions 1060 may be executable to cause the processor 1010 to receive and process proximity data associated with a first device of a plurality of devices. The proximity data indicates a relative location of each of one or more devices of the plurality of devices with respect to the first device. The computer executable instructions 1060 are further executable to cause the processor 1010 to determine an estimated intermodulation product. The estimated intermodulation product is calculated based on the proximity data.

A display controller 1026 is coupled to the processor 1010 and to a display device 1028. A coder/decoder (CODEC) 1034 can also be coupled to the processor 1010. A speaker 1036 and a microphone 1038 can be coupled to the CODEC 1034.

A first wireless interface 1080 can be coupled to the processor 1010 and to a first antenna 1042 such that wireless data received via the first antenna 642 and the wireless interface 1080 can be provided to the processor 1010. The first wireless interface 1080 may include a digital transceiver 1082 that includes an ultra-wideband component 1084. For example, the digital transceiver 1080 may include the digital transceiver 112 of the first microphone transmitter 110, the digital transceiver 122 of the second microphone transmitter 120, the digital transceiver 132 of the microphone receiver 130, the digital transceiver 142 of the control device 140 of FIG. 1, the digital transceiver 212 of the IEM receiver 210, or the digital transceiver 232 of the IEM transmitter 230 of FIG. 2.

A second wireless interface 1040 can be coupled to the processor 1010 and to a second antenna 1043 such that wireless data received via the second antenna 1043 and the wireless interface 1040 can be provided to the processor 1010. The second wireless interface 1040 may include an analog transceiver 1046. For example, the analog transceiver 1040 may include the analog transceiver 114 of the first microphone transmitter 110, the analog transceiver 124 of the second microphone transmitter 120, the analog receiver 134 of the microphone receiver 130 of FIG. 1, the analog receiver 214 of the IEM receiver 210, or the analog transceiver 234 of the IEM transmitter 230 of FIG. 2.

In a particular embodiment, the processor 1010, the display controller 1026, the memory 1032, the CODEC 1034, the first wireless interface 1080, and the second wireless interface 1046 are included in a system-in-package or system-on-chip device 1022. In a particular embodiment, an input device 1030 and a power supply 1044 are coupled to the system-on-chip device 1022. Moreover, in a particular embodiment, as illustrated in FIG. 10, the display device 1028, the input device 1030, the speaker 1036, the microphone 1038, the first wireless antenna 1042, the second wireless antenna 1043, and the power supply 1044 are external to the system-on-chip device 1022. However, each of the display device 1028, the input device 1030, the speaker 1036, the microphone 1038, the first wireless antenna 1042, the second wireless antenna 1043, and the power supply 1044 can be coupled to a component of the system-on-chip device 1022, such as an interface or a controller.

In conjunction with one or more of the described embodiments, an apparatus is disclosed that includes means for receiving proximity data associated with a first device of a plurality of devices. The proximity data indicates a relative location of each of one or more devices of the plurality of devices with respect to the first device. The means for receiving may include the digital transceiver 112 of the first microphone transmitter 110, the digital transceiver 122 of the second microphone transmitter 120, the digital transceiver of the microphone receiver 130, the digital transceiver 142 of the control device 140, the controller 144 of FIG. 1, the digital transceiver 212 of the IEM receiver 210, the digital transceiver 232 of the IEM transmitter 230, the controller 504 of FIG. 5, the controller 602 of FIG. 6, the first wireless interface 1080, the controller 1072 of FIG. 10, one or more other devices or circuits configured to receive the proximity data, or any combination thereof.

The apparatus may also include means for determining an estimated intermodulation product. The estimated intermodulation product may be calculated based on the proximity data. The means for determining may include the controller 144, the intermodulation product estimation module 148 of FIG. 1, the controller 504 of FIG. 5, the controller 602 of FIG. 6, the processor 1010 or the controller 1072 of FIG. 10, one or more other devices or circuits configured to determine intermodulation products, or any combination thereof.

One or more of the disclosed embodiments may be implemented in a system or an apparatus, such as the device 1000, that may include a wireless microphone transmitter, a wireless microphone receiver, a wireless in-ear monitor receiver, a wireless in-ear monitor transmitter, or a combination thereof.

Although one or more of FIGS. 1-10 may illustrate systems, apparatuses, and/or methods according to the teachings of the disclosure, the disclosure is not limited to these illustrated systems, apparatuses, and/or methods. Embodiments of the disclosure may be suitably employed in any device that includes integrated circuitry including a processor and a memory.

Those of skill would further appreciate that the various illustrative logical blocks, configurations, modules, circuits, and algorithm steps described in connection with the embodiments disclosed herein may be implemented as electronic hardware, computer software executed by a processor, or a combination thereof. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An illustrative storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A system comprising:
a controller configured to:
receive proximity data associated with a first device of a plurality of devices, wherein the proximity data indicates a relative location of each of one or more devices of the plurality of devices with respect to the first device;
determine an estimated intermodulation product, wherein the estimated intermodulation product is determined based on the proximity data; and
initiate transmission of one or more commands to at least one device of the plurality of devices, the one or more commands based on the estimated intermodulation product.

2. The system of claim 1, wherein a first relative location of a second device of the one or more devices with respect to the first device corresponds to a distance between the second device and the first device.

3. The system of claim 1, wherein one or more of the plurality of devices each include a corresponding an ultra-wideband component, and wherein first device determines the proximity data using the ultra-wideband component.

4. The system of claim 1, wherein the plurality of devices comprise a wireless microphone transmitter, a microphone receiver, a wireless in-ear-monitor receiver, an in-ear-monitor transmitter, or a combination thereof.

5. The system of claim 1, wherein the controller is a component of a microphone receiver.

6. The system of claim 1, wherein the first device comprises a wireless microphone transmitter.

7. The system of claim 1, wherein the proximity data is received by the controller from the first device at least in part via a mesh network comprising multiple devices of the plurality of devices.

8. The system of claim 1, wherein the controller is further configured to receive a data communication from the first device, the data communication including the proximity data, a transmitter power level of the first device, a device identifier associated with the first device, or a combination thereof.

9. The system of claim 1, wherein the controller is further configured to receive, from a microphone receiver of the plurality of devices, a signal-to-noise ratio value of an analog audio signal received at the microphone receiver via an audio channel of an audio spectrum from a microphone transmitter or an in-ear-monitor transmitter.

10. The system of claim 1, wherein the controller is further configured to receive, from a microphone receiver, a received signal strength value of a digital communication received at the microphone receiver from a second device of the plurality of devices via a particular digital control channel of a wireless network of the microphone system.

11. The system of claim 1, wherein the controller is further configured to compare the estimated intermodulation product to a threshold.

12. The system of claim 11, wherein the threshold includes a range of values.

13. The system of claim 1, wherein the controller is further configured to identify a corrective action when the estimated intermodulation product does not satisfy the threshold.

14. The system of claim 1, wherein the corrective action is based on the proximity data, the plurality of estimated intermodulation products, the signal-to-noise ratio value, the received signal strength value, or a combination thereof.

15. The system of claim 1, wherein the one or more commands cause at least one device of the plurality of devices to change from a first audio channel to a second audio channel, adjust a transmission power level, activate intermodulation cancellation circuitry, adjust a bias current associated with an amplifier of a transmitter circuit, adjust a bias voltage associated with the amplifier, or a combination thereof.

16. The system of claim 1, wherein the controller is configured to communicate with at least a subset of the plurality of devices using a digital control channel of a wireless network.

17. The system of claim 17, wherein the digital control channel is included in a 900 megahertz (MHz) frequency band of the wireless network.

18. The system of claim 1, wherein the controller is further configured to identify an audio channel associated with the first device, a transmission power level associated with the first device, a priority associated with the first device, or a combination thereof.

19. The system of claim 1, wherein the controller is further configured to:
identify multiple devices associated with generation of the estimated intermodulation product; and
initiate a frequency channel assignment change command for each device of the multiple devices to a set of contiguous and unused audio channels, wherein each device of the multiple devices is assigned to a different frequency channel of the set of contiguous and unused frequency channels in response to the frequency channel assignment change command.

20. A method comprising:
receiving proximity data associated with a first device of a plurality of devices, wherein the proximity data indicates a relative location of each of one or more devices of the plurality of devices with respect to the first device; and
determining an estimated intermodulation product, wherein the estimated intermodulation product is determined based on the proximity data.

21. The method of claim 20, wherein one or more of the plurality of devices include a corresponding ultra-wideband component.

22. The method of claim 20, further comprising receiving a data communication from the first device, the data communication including the proximity data, a transmitter power level of the first device, a device identifier associated with the first device, a frequency channel allocated to the first device, or a combination thereof.

23. The method of claim 20, further comprising identifying multiple devices associated with generation of the estimated intermodulation product.

24. The method of claim 20, wherein the estimated intermodulation product affects a signal transmitted by the first device.

25. The method of claim 20, further comprising comparing the estimated intermodulation product to a threshold, wherein a frequency of the estimated intermodulation product is the same frequency as a frequency channel allocated to the first device.

26. The method of claim 25, wherein the threshold is associated with a power of the estimated intermodulation product.

27. The method of claim 26, further comprising identifying a corrective action when the estimated intermodulation product does not satisfy the threshold.

28. An apparatus comprising:
means for receiving proximity data associated with a first device of a plurality of devices, wherein the proximity data indicates a relative location of each of one or more devices of the plurality of devices with respect to the first device; and
means for determining an estimated intermodulation product, wherein the estimated intermodulation product is determined based on the proximity data.

29. The apparatus of claim 28, further comprising means for comparing the estimated intermodulation product to a threshold.

30. The apparatus of claim 28, further comprising means for storing data associated with the first device.

31. The apparatus of claim 30, wherein the data associated with the first device includes the proximity data, a transmitter power level of the first device, a device identifier associated with the first device, a frequency channel allocated to the first device, or a combination thereof.

32. The apparatus of claim 28, further comprising means for receiving a data communication from the first device.

33. The apparatus of claim 32, wherein the data communication includes the proximity data, a transmitter power level of the first device, a device identifier associated with the first device, a frequency channel allocated to the first device, or a combination thereof.

34. A non-transitory computer readable medium includes instructions that, when executed by a processor, cause the processor to:
receive proximity data associated with a first device of a plurality of devices, wherein the proximity data indicates a relative location of each of one or more devices of the plurality of devices with respect to the first device; and
determine an estimated intermodulation product, wherein the estimated intermodulation product is determined based on the proximity.
